(19) United States
(12) Patent Application Publication
(10) Pub. No.: US 2024/0354913 A1
(43) Pub. Date: Oct. 24, 2024

(54) INFORMATION PROCESSING METHOD, INFORMATION PROCESSING DEVICE, AND PROGRAM

(71) Applicant: SONY GROUP CORPORATION, TOKYO (JP)

(72) Inventors: KENJI IKEDA, TOKYO (JP); HIROKAZU TATSUTA, TOKYO (JP); KAZUHIRO NAKAGAWA, TOKYO (JP); SAKIKO YASUKAWA, TOKYO (JP)

(21) Appl. No.: 18/560,699

(22) PCT Filed: Feb. 24, 2022
(86) PCT No.: PCT/JP2022/007565

§ 371 Date: Nov. 14, 2023

(30) Foreign Application Priority Data
May 27, 2021 (JP) 2021-089480

(51) Int. Cl. G06T 5/90; G06T 7/00; G06T 7/11; G06T 7/62

(52) U.S. Cl. CPC G06T 5/90; G06T 7/0012; G06T 7/11; G06T 7/62; G06T 2207/10056; G06T 2207/10064; G06T 2207/30024

(57) ABSTRACT

There are provided an information processing method, an information processing device, and a program capable of displaying an image in a more appropriate dynamic range.

The information processing method includes: a storage step of storing first image data of a unit region image, a unit region being each region obtained by dividing a fluorescence image into a plurality of regions, and a first value indicating a predetermined pixel value range for each piece of the first image data in association with each other; and a conversion step of converting a pixel value of a combination image of a combination of the unit region images that have been selected on the basis of a representative value selected from among the first values associated with the unit region images of the combination of the unit region images that have been selected.

### TECHNICAL FIELD

The present disclosure relates to an information processing method, an information processing device, and a program.

### BACKGROUND ART

In a diagnosis of a pathological image, a pathological image diagnosis method by fluorescent staining has been proposed as a technique excellent in quantitativity and polychromaticity. A fluorescence technique is advantageous in that multiplexing is easier than colored staining and detailed diagnostic information can be obtained. Even in fluorescence imaging other than pathological diagnosis, an increase in the number of colors makes it possible to examine various antigens present in a sample at once.

As a configuration for realizing such a pathological image diagnosis method by fluorescent staining, a fluorescence observation device using a line spectrometer has been proposed. The line spectrometer irradiates a fluorescently stained pathological specimen with linear line illumination, disperses fluorescence excited by the line illumination by a spectrometer, and captures an image. Fluorescence image data obtained by imaging is sequentially output, for example, in a line direction by line illumination, which is sequentially repeated in a wavelength direction by spectroscopy, so that the fluorescence image data is continuously output without interruption.

Furthermore, in the fluorescence observation device, imaging of a pathological specimen is performed by scanning in a direction vertical to a line direction by line illumination, whereby spectral information regarding the pathological specimen based on captured image data can be handled as two-dimensional information.

### CITATION LIST

### Patent Document

PATENT DOCUMENT 1: International Publication No. 2019/230878

### SUMMARY OF THE INVENTION

### Problems to be Solved by the Invention

However, brightness of a fluorescence image is less likely to be predicted than that of a bright-field illumination image, and the dynamic range of a fluorescence image is wider than that of a bright-field illumination image. For this reason, if uniform luminance display is performed on an entire image as in a bright-field illumination image, there is a possibility that a necessary signal cannot be visually recognized depending on a place in some cases. Therefore, the present disclosure provides an information processing method, an information processing device, and a program capable of displaying an image in a more appropriate dynamic range.

### Solutions to Problems

In order to solve the problem described above, according to the present disclosure, there is provided an information processing method including:

a storage step of storing first image data of a unit region image, a unit region being each region obtained by dividing a fluorescence image into a plurality of regions, and a first value indicating a predetermined pixel value range for each piece of the first image data in association with each other; and a conversion step of converting a pixel value of a combination image of a combination of the unit region images that have been selected on the basis of a representative value selected from among the first values associated with the unit region images of the combination of the unit region images that have been selected.

The combination of the unit region images that have been selected corresponds to an observation range to be displayed on a display section, and a range of the combination of the unit region images may be changed according to the observation range. The method may further include a display control step of causing the display section to display a range corresponding to the observation range.

The observation range may correspond to an observation range of a microscope, and the range of the combination of the unit region images may be changed according to a magnification of the microscope.

The first image data may be image data in which a range of a dynamic range is adjusted on the basis of a pixel value range acquired in original image data of the first image data according to a predetermined rule.

A pixel value of the original image data may be obtained by multiplying the first image data by the representative value associated with the first image data.

The storage step may further store second image data having a size different from a size of a region of the first image data, the second image data being obtained by subdividing the fluorescence image into a plurality of regions, and a first value indicating a pixel value range for each piece of the second image data in association with each other.

A combination of pieces of the second image data corresponding to the observation range may be selected in a case where a magnification of the microscope exceeds a predetermined value, and the conversion step may convert a pixel value for the combination of the pieces of the second image data that has been selected on the basis of a representative value selected from the first values associated with the pieces of the second image data of the combination of the pieces of the second image data that has been selected.

The pixel value range may be a range based on a statistic in the original image data corresponding to the first image data.

The statistic may be any one of a maximum value, a mode, and a median.

The pixel value range may be a range between a minimum value in the original image data and the statistic.

The first image data may be data obtained by dividing a pixel value of the original image data corresponding to the unit region image by the first value, and the conversion step may multiply each piece of the first image data in the unit region image that has been selected by the corresponding first value and divide an obtained value by a maximum value of the first values associated with the unit region images of the combination of unit region images that have been selected.

The method may further include:
a first input step of inputting a method of calculating the statistic;
an analysis step of calculating the statistic according to an input of the input section; and
a data generation step of generating first image data obtained by dividing a fluorescence image into a plurality of regions and a first value indicating a pixel value range for each piece of the first image data on the basis of an analysis in the analysis step.

The method may further include a second input step of further inputting information regarding at least one of the display magnification or the observation range, and the conversion step may select a combination of the first images according to an input of the second input step.

The display control step may cause the display section to display display modes related to the first input step and the second input step, the method may further include an operation step of giving an instruction on a position of any one of the display modes, and the first input step and the second input step may input related information according to an instruction in the operation step.

The fluorescence image is one of a plurality of fluorescence images generated by an imaging target for a plurality of fluorescence wavelengths, and the method may further include a data generation step of dividing each of the plurality of fluorescence images into image data and a coefficient that is the first value for the image data.

The method may further include an analysis step of performing cell analysis on the basis of a pixel value converted in the conversion step, and the analysis step of performing the cell analysis may be performed on the basis of an image range of a range on which an instruction is given by an operator.

According to the present disclosure, there is provided an information processing device including:

a storage section that stores first image data obtained by dividing a fluorescence image into a plurality of regions, and a first value indicating a predetermined pixel value range for each piece of the first image data in association with each other; and a conversion section that converts a pixel value of a combination image of a combination of the first images that have been selected on the basis of a representative value selected from among the first values associated with the first images of the combination of the first images that have been selected.

According to the present disclosure, there is provided a program causing an information processing device to execute: a storage step of storing first image data obtained by dividing a fluorescence image into a plurality of regions, and a first value indicating a predetermined pixel value range for each piece of the first image data in association with each other; and a conversion step of converting a pixel value of a combination image of a combination of the first images that have been selected on the basis of a representative value selected from among the first values associated with the first images of the combination of the first images that have been selected.

### BRIEF DESCRIPTION OF DRAWINGS

FIG. 1 is a schematic view for explaining line spectroscopy applicable to an embodiment.

FIG. 2 is a flowchart illustrating a processing example of line spectroscopy.

FIG. 3 is a schematic block diagram of a fluorescence observation device according to one embodiment of the present technology.

FIG. 4 is a view illustrating an example of an optical system in the fluorescence observation device.

FIG. 5 is a schematic view of a pathological specimen which is an observation target.

FIG. 6 is a schematic view illustrating a state of line illuminations applied to the observation target.

FIG. 7 is a view for explaining a spectral data acquisition method in a case where an imaging element in the fluorescence observation device includes a single image sensor.

FIG. 8 is a diagram illustrating wavelength characteristics of spectral data acquired in FIG. 6.

FIG. 9 is a view for explaining a spectral data acquisition method in a case where the imaging element includes a plurality of image sensors.

FIG. 10 is a conceptual view illustrating a scanning method of line illumination applied to the observation target.

FIG. 11 is a conceptual view illustrating three-dimensional data (X, Y, λ) acquired by a plurality of line illuminations.

FIG. 12 is a table illustrating a relationship between an irradiation line and a wavelength.

FIG. 13 is a flowchart illustrating an example of a procedure of processing executed in an information processing device (processing unit).

FIG. 14 is a view schematically illustrating a flow of spectral data (x, λ) acquisition processing according to the embodiment.

FIG. 15 is a view schematically illustrating a plurality of unit blocks.

FIG. 16 is a schematic view illustrating an example of spectral data (x, λ) illustrated in the section (b) of FIG. 14.

FIG. 17 is a schematic view illustrating an example of spectral data (x, λ) in which an arrangement order of data is changed.

FIG. 18 is a block diagram illustrating a configuration example of a gradation processing section.

FIG. 19 is a diagram conceptually describing an example of processing performed by the gradation processing section.

FIG. 20 is a diagram illustrating an example of a data name corresponding to an imaging position.

FIG. 21 is a diagram illustrating an example of a data format of each unit rectangular block.

FIG. 22 is a view illustrating an image pyramid structure for explaining a processing example of an image group generation section.

FIG. 23 is a view illustrating an example in which a stitching image (WSI) is regenerated as an image pyramid structure.

FIG. 24 is an example of a display screen generated by a display control section.

FIG. 25 is a view illustrating an example in which a display region is changed.

FIG. 26 is a flowchart illustrating a processing example of the information processing device.

FIG. 27 is a schematic block diagram of a fluorescence observation device according to a second embodiment.

FIG. 28 is a diagram schematically illustrating a processing example of a second analysis section.

FIG. 29 is a diagram illustrating a processing example of a second analysis section according to Modification 1 of the second embodiment.

FIG. 30 is a diagram schematically illustrating a processing example of a second analysis section according to Modification 2 of the second embodiment.

### MODE FOR CARRYING OUT THE INVENTION

Hereinafter, embodiments of an information processing method, an information processing device, and a program will be described with reference to the drawings. Hereinafter, the main components of the information processing method, the information processing device, and the program will be mainly described; however, the information processing method, the information processing device, and the program may include components and functions that are not illustrated or described. The following description does not exclude components and functions that are not illustrated or described.

### First Embodiment

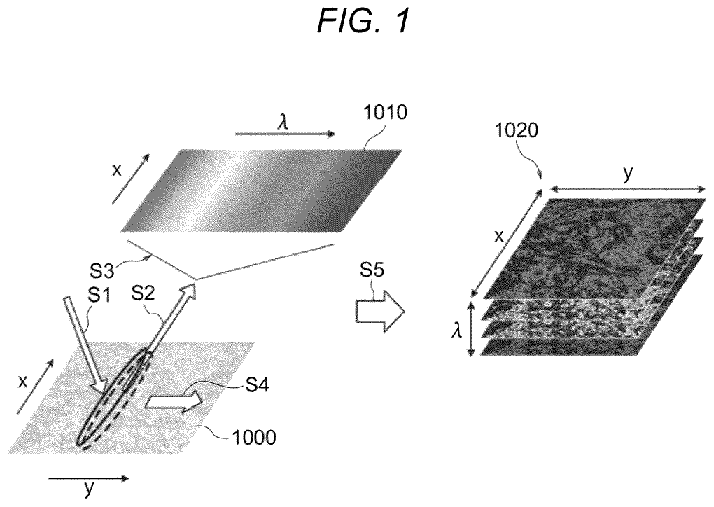

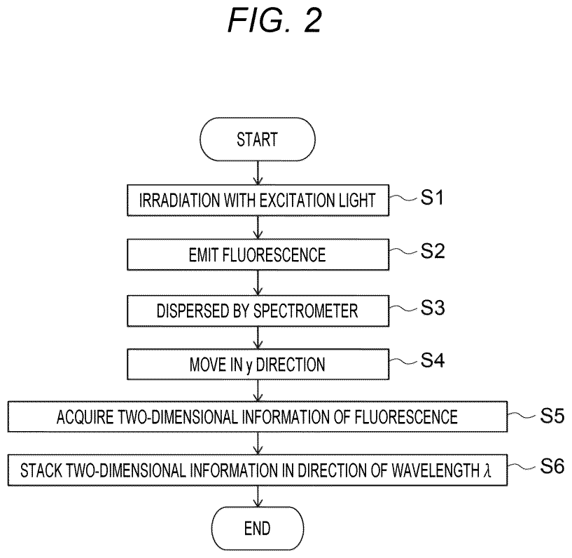

Prior to describing the embodiments of the present disclosure, line spectroscopy will be schematically described on the basis of FIG. 2 with reference to FIG. 1 for easy understanding. FIG. 1 is a schematic view for explaining line spectroscopy applicable to an embodiment. FIG. 2 is a flowchart illustrating a processing example of line spectroscopy. As illustrated in FIG. 2, a fluorescently stained pathological specimen 1000 is irradiated with linear excitation light by, for example, a laser beam by line illumination (step S1). In the example of FIG. 1, the pathological specimen 1000 is irradiated with the excitation light in a line shape parallel to the x direction.

In the pathological specimen 1000, a fluorescent substance by fluorescent staining is excited by irradiation with the excitation light, and emits fluorescence linearly (step S2). This fluorescence is dispersed by a spectrometer (step S3) and imaged by a camera. Here, an imaging element of the camera has a configuration in which pixels are arranged in a two-dimensional lattice shape including pixels aligned in a row direction (referred to as the x direction) and pixels aligned in a column direction (referred to as a y direction). Image data 1010 that has been captured has a structure including position information of the line direction in the x direction and information of a wavelength λ by spectroscopy in the y direction.

When the imaging by irradiation of excitation light of one line is completed, for example, the pathological specimen 1000 is moved by a predetermined distance in the y direction (step S4), and the next imaging is performed. By this imaging, image data 1010 in the next line in the y direction is acquired. By repeatedly executing this operation a predetermined number of times, it is possible to acquire two-dimensional information of fluorescence emitted from the pathological specimen 1000 for each wavelength λ (step S5). Data obtained by stacking two-dimensional information at each wavelength λ in the direction of the wavelength λ is generated as a spectral data cube 1020 (step S6). Note that, in the present embodiment, data obtained by stacking two-dimensional information at the wavelength λ in the direction of the wavelength λ is referred to as a spectral data cube.

In the example of FIG. 1, the spectral data cube 1020 has a structure including two-dimensional information of the pathological specimen 1000 in the x direction and the y direction and including information of the wavelength λ in the height direction (depth direction). With such a data configuration of the spectral information from the pathological specimen 1000, it is possible to easily perform two-dimensional analysis on the pathological specimen 1000.

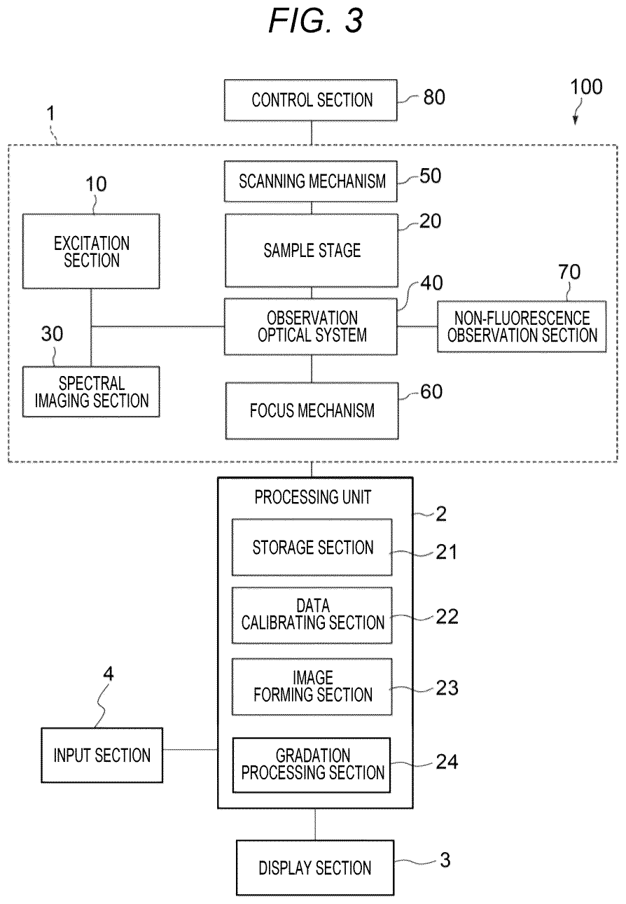

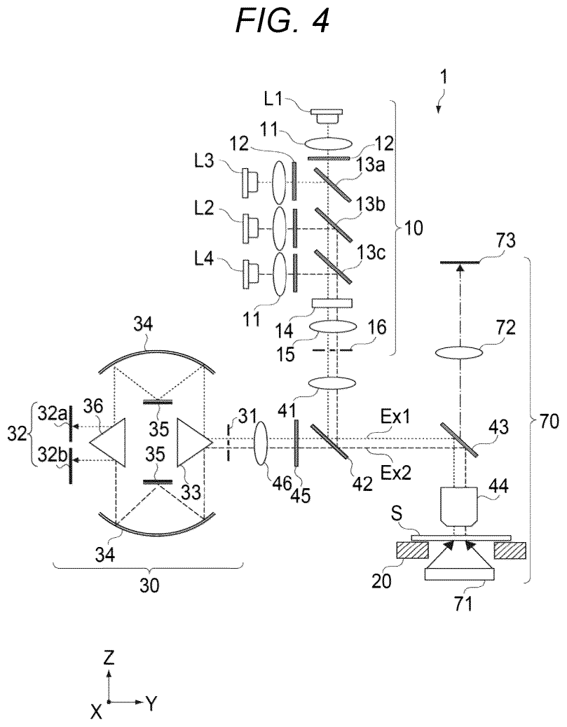

FIG. 3 is a schematic block diagram of a fluorescence observation device according to an embodiment of the present technology, and FIG. 4 is a diagram illustrating an example of an optical system in the fluorescence observation device.

### [Overall Configuration]

A fluorescence observation device 100 of the present embodiment includes an observation unit 1, a processing unit (information processing device) 2, and a display section 3. The observation unit 1 includes an excitation section 10 that irradiates a pathological specimen (pathological sample) with a plurality of line illuminations having different wavelengths arranged in parallel with different axes, a stage 20 that supports the pathological specimen, and a spectral imaging section 30 that acquires a fluorescence spectrum (spectral data) of the pathological specimen excited linearly.

Here, the term “parallel with different axes” means that the plurality of line illuminations has different axes and is parallel to each other. The term “different axes” means that the axes are not coaxial, and the distance between the axes is not particularly limited. The term “parallel” is not limited to parallel in a strict sense, and includes a state of being substantially parallel. For example, there may be distortion from an optical system such as a lens or deviation from a parallel state due to manufacturing tolerance, and this case is also regarded as parallel.

The information processing device 2 typically forms an image of the pathological specimen (hereinafter also referred to as a sample S) acquired by the observation unit 1 or outputs a distribution of the fluorescence spectrum of the pathological specimen on the basis of the fluorescence spectrum. The image herein refers to a constituent ratio of dyes constituting the spectrum, autofluorescence derived from the sample, and the like, a waveform converted into RGB (red, green, and blue) colors, a luminance distribution in a specific wavelength band, and the like. Note that in the present embodiment, two-dimensional image information generated on the basis of the fluorescence spectrum is referred to as a fluorescence image in some cases. Note that the information processing device 2 according to the present embodiment corresponds to the information processing device.

The display section 3 is, for example, a liquid crystal monitor. An input section 4 is, for example, a pointing device, a keyboard, a touch panel, or another operation device. In a case where the input section 4 includes a touch panel, the touch panel can be integrated with the display section 3.

The excitation section 10 and the spectral imaging section 30 are connected to the stage 20 via an observation optical system 40 such as an objective lens 44. The observation optical system 40 has an autofocus (AF) function of following an optimum focus by a focus mechanism 60. A non-fluorescence observation section 70 for dark field observation, bright field observation, or the like may be connected to the observation optical system 40.

The fluorescence observation device 100 may be connected to a control section 80 that controls the excitation section (control of an LD and a shutter), an XY stage which is a scanning mechanism, the spectral imaging section (camera), the focus mechanism (detector and Z stage), the non-fluorescence observation section (camera), and the like.

The excitation section 10 includes a plurality of light sources L1, L2, . . . that can output light of a plurality of excitation wavelengths Ex1, Ex2, . . . . The plurality of light sources typically includes a light emitting diode (LED), a laser diode (LD), a mercury lamp, and the like, and light of each of them forms a line illumination and is applied to the sample S on the stage 20.

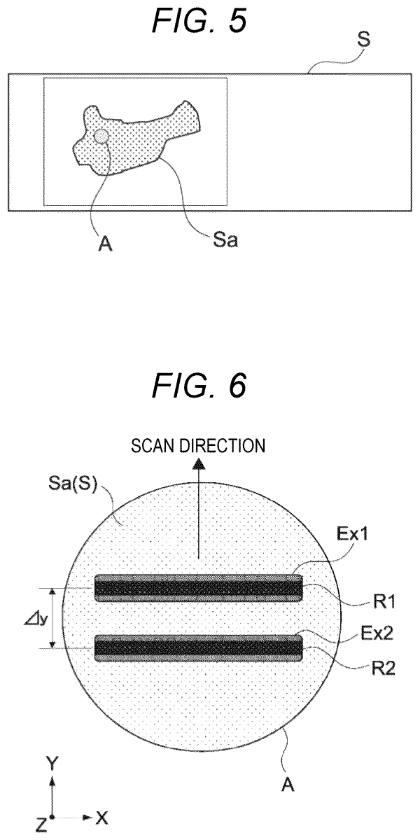

FIG. 5 is a schematic view of the pathological specimen which is an observation target. FIG. 6 is a schematic view illustrating a state of line illuminations applied to the observation target.

The sample S is typically configured by a slide including an observation target Sa such as a tissue section as illustrated in FIG. 5, but of course is not limited thereto. The sample S (observation target Sa) is stained with a plurality of fluorescent dyes. The observation unit 1 enlarges and observes the sample S at a desired magnification. If the portion A in FIG. 5 is enlarged, as illustrated in FIG. 6, a plurality of line illuminations (two in the illustrated example (Ex1, Ex2)) is arranged in an illumination section, and imaging areas R1 and R2 of the spectral imaging section 30 are arranged so as to overlap with the illumination areas of the line illuminations. The two line illuminations Ex1 and Ex2 are parallel to each other in the Z-axis direction and is disposed at a predetermined distance (Δy) therebetween in the Y-axis direction.

The imaging areas R1 and R2 correspond to respective slit portions of an observation slit 31 (see FIG. 4) in the spectral imaging section 30. That is, as many slit portions of the spectral imaging section 30 as the number of line illuminations are arranged. In FIG. 6, the line width of the illumination is wider than the slit width, but the magnitude relationship of them may be vice versa. In a case where the line width of the illumination is greater than the slit width, the alignment margin of the excitation section 10 with respect to the spectral imaging section 30 can be increased.

The wavelength constituting the first line illumination Ex1 and the wavelength constituting the second line illumination Ex2 are different from each other. The linear fluorescence excited by the line illuminations Ex1 and Ex2 is observed in the spectral imaging section 30 via the observation optical system 40.

The spectral imaging section 30 includes the observation slit 31 having the plurality of slit portions through which fluorescence excited by the plurality of line illuminations can pass, and at least one imaging element 32 capable of individually receiving the fluorescence having passed through the observation slit 31. As the imaging element 32, a two-dimensional imager such as a charge coupled device (CCD) or a complementary metal oxide semiconductor (CMOS) is adopted. By arranging the observation slit 31 on an optical path, the fluorescence spectra excited in the respective lines can be detected without overlapping.

The spectral imaging section 30 acquires spectral data (x, λ) of fluorescence using a pixel array in one direction (for example, a vertical direction) of the imaging element 32 as a channel of a wavelength from each of the line illuminations Ex1 and Ex2. The spectral data (x, λ) that has been obtained is recorded in the information processing device 2 in a state of being associated with which excitation wavelength the spectral data is excited at.

The information processing device 2 can be realized by hardware elements user for a computer, such as a central processing unit (CPU), a random access memory (RAM), a read only memory (ROM) and the like, and necessary software. In place of or in addition to the CPU, a programmable logic device (PLD) such as a field programmable gate array (FPGA), a digital signal processor (DSP), an application specific integrated circuit (ASIC), or the like may be used. The information processing device 2 includes a storage section 21, a data configuration section 22, an image forming section 23, and a gradation processing section 24. The information processing device 2 can configure functions of the data configuration section 22, the image forming section 23, and the gradation processing section 24 by executing a program stored in the storage section 21. Note that the data configuration section 22, the image forming section 23, and the gradation processing section 24 may be configured by a circuit.

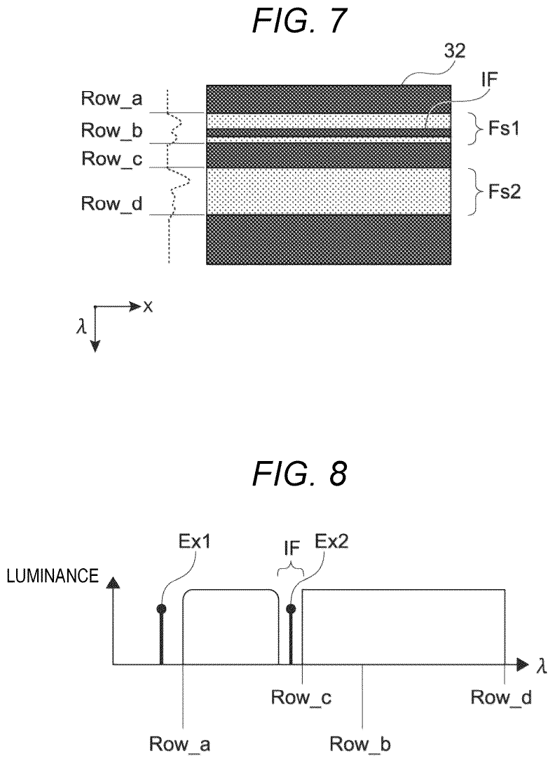

The information processing device 2 includes the storage section 21 that stores spectral data indicating a correlation between wavelengths of the plurality of line illuminations Ex1 and Ex2 and fluorescence received by the imaging element 32. A storage device such as a nonvolatile semiconductor memory or a hard disk drive is used for the storage section 21, and a standard spectrum of autofluorescence related to the sample S and a standard spectrum of a single dye staining the sample S are stored in advance. For example, the spectral data (x, λ) received by the imaging element 32 is acquired as illustrated in FIGS. 7 and 8 and stored in the storage section 21. In the present embodiment, the storage section that stores the autofluorescence of the sample S and the standard spectrum of the single dye and the storage section that stores the spectral data (measurement spectrum) of the sample S acquired by the imaging element 32 are configured by the common storage section 21, but the present invention is not limited thereto, and may be configured by separate storage sections.

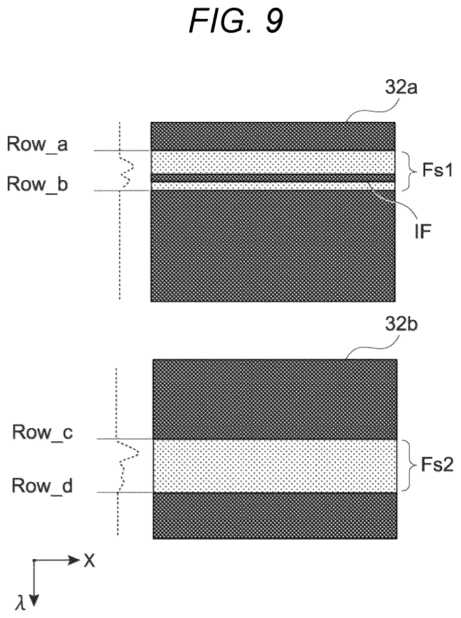

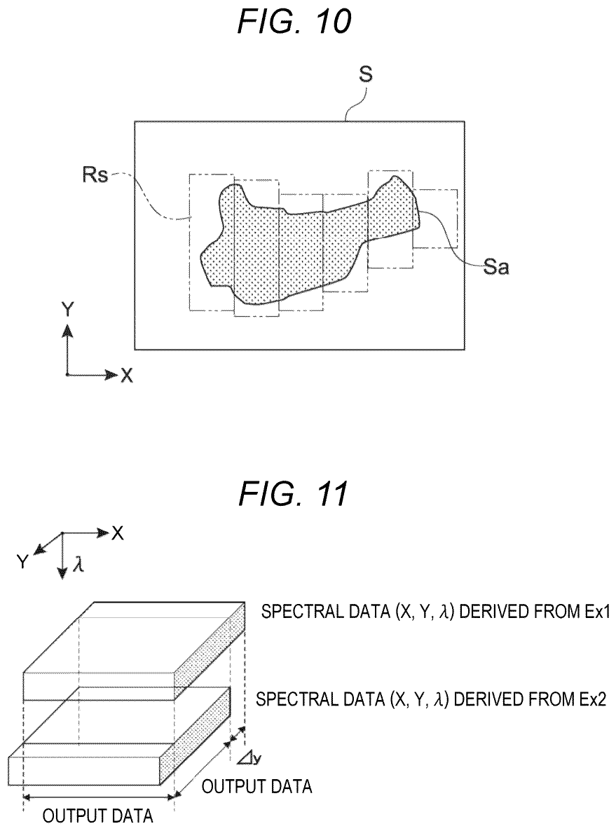

FIG. 7 is a view for explaining a spectral data acquisition method in a case where the imaging element in the fluorescence observation device 100 includes a single image sensor. FIG. 8 is a diagram illustrating wavelength characteristics of the spectral data acquired in FIG. 6. In this example, fluorescence spectra Fs1 and Fs2 excited by the line illuminations Ex1 and Ex2 are finally formed as images on the light receiving surface of the imaging element 32 in a state of being shifted by an amount proportional to Δy (see FIG. 6) via a spectroscopic optical system (described later). FIG. 9 is a view for explaining a spectral data acquisition method in a case where the imaging element includes a plurality of image sensors. FIG. 10 is a conceptual view illustrating a scanning method of the line illumination applied to the observation target. FIG. 11 is a conceptual view illustrating three-dimensional data (X, Y, λ) acquired by the plurality of line illuminations. Hereinafter, the fluorescence observation device 100 will be described in more detail with reference to FIGS. 7 to 11.

As illustrated in FIG. 7, information obtained from the line illumination Ex1 is recorded as Row_a and Row_b, and information obtained from the line illumination Ex2 is recorded as Row_c and Row_d. Data other than these regions is not read. As a result, the frame rate of the imaging element 32 can be advanced by Row_full/(Row_b-Row_a+Row_d-Row_c) times than that in a case where reading is performed in a full frame.

As illustrated in FIG. 4 again, a dichroic mirror 42 and a band-pass filter 45 are inserted in the middle of the optical path so that the excitation light (Ex1, Ex2) does not reach the imaging element 32. In this case, an intermittent part IF occurs in the fluorescence spectrum Fs1 formed as an image on the imaging element 32 (See FIGS. 7 and 8). The frame rate can be further improved by excluding the intermittent part IF as described from the reading region.

As illustrated in FIG. 4, the imaging element 32 may include a plurality of imaging elements 32a and 32b capable of receiving fluorescence that has passed through the observation slit 31. In this case, the fluorescence spectra Fs1 and Fs2 excited by the line illuminations Ex1 and Ex2 are acquired on the imaging elements 32a and 32b as illustrated in FIG. 9, and are stored in the storage section 21 in association with the excitation lights.

The present invention is not limited to a case where each of the line illuminations Ex1 and Ex2 has a single wavelength, and each of the line illuminations Ex1 and Ex2 may have a plurality of wavelengths. In a case where the line illuminations Ex1 and Ex2 each have a plurality of wavelengths, the fluorescence excited by each of them also includes a plurality of spectra. In this case, the spectral imaging section 30 includes a wavelength dispersion element for separating the fluorescence into spectra derived from the excitation wavelengths. The wavelength dispersion element includes a diffraction grating, a prism, or the like, and is typically disposed on an optical path between the observation slit 31 and the imaging element 32.

The observation unit 1 further includes a scanning mechanism 50 that scans the stage 20 with the plurality of line illuminations Ex1 and Ex2 in the Y-axis direction, that is, in the arrangement direction of the line illuminations Ex1 and Ex2. By using the scanning mechanism 50, dye spectra (fluorescence spectra) that are spatially separated by Δy on the sample S (observation target Sa) and are excited at different excitation wavelengths can be continuously recorded in the Y-axis direction. In this case, for example, as illustrated in FIG. 10, an imaging region Rs is divided into a plurality of regions in the X-axis direction, and an operation of scanning the sample S in the Y-axis direction, then moving in the X-axis direction, and further performing scanning in the Y-axis direction is repeated. An optical spectrum image from the sample excited at several excitation wavelengths can be captured in a single scan.

With the scanning mechanism 50, the stage 20 is typically passed in the Y-axis direction; however, the plurality of line illuminations Ex1 and Ex2 may be passed in the Y-axis direction by a galvanometer mirror disposed in the middle of the optical system. Finally, three-dimensional data of (X, Y, λ) as illustrated in FIG. 11 is acquired for each of the plurality of line illuminations Ex1 and Ex2. Since the three-dimensional data derived from each of the line illuminations Ex1 and Ex2 is data whose coordinates are shifted by Δy with respect to the Y axis, the three-dimensional data is corrected on the basis of Δy recorded in advance or a value of Δy calculated from the output of the imaging element 32 and output.

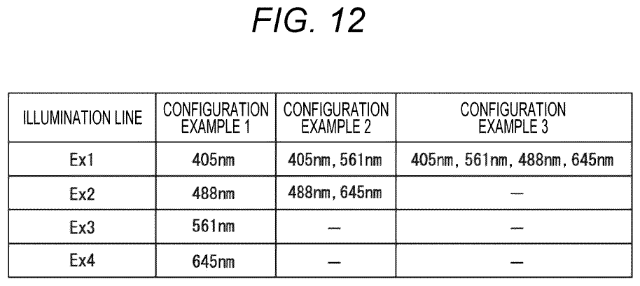

In the above example, the number of line illuminations as excitation light is two. However, the number of the line illuminations is not limited to two, and may be three, four, or five or more. Furthermore, each line illumination may include a plurality of excitation wavelengths selected so that color separation performance is not degraded as much as possible. Furthermore, even if there is one line illumination, if the line illumination is an excitation light source having a plurality of excitation wavelengths and each excitation wavelength is recorded in association with Row data obtained by the imaging element, it is possible to obtain a polychromatic spectrum although it is not possible to obtain separability as high as that in the case of “parallel with different axes”. FIG. 12 is a table illustrating a relationship between an irradiation line and a wavelength. For example, a configuration as illustrated in FIG. 12 may be adopted.

### [Observation Unit]

Next, details of the observation unit 1 will be described with reference to FIG. 4. Here, an example in which the observation unit 1 is configured in the configuration example 2 in FIG. 12 will be described.

The excitation section 10 includes a plurality of (four in this example) excitation light sources L1, L2, L3, and L4. The excitation light sources L1 to L4 include laser light sources that output laser beams having a wavelength of 405 nm, 488 nm, 561 nm, and 645 nm, respectively.

The excitation section 10 further includes a plurality of collimator lenses 11 and laser line filters 12 corresponding to the excitation light sources L1 to L4, respectively, dichroic mirrors 13a, 13b, and 13c, a homogenizer 14, a condenser lens 15, and an incident slit 16.

The laser beam emitted from the excitation light source L1 and the laser beam emitted from the excitation light source L3 are collimated by the collimator lenses 11, transmitted through the laser line filters 12 used to cut off edge portions of respective wavelength bands, and made coaxial by the dichroic mirror 13a. The two coaxial laser beams are further formed into a beam by the homogenizer 14 such as a fly-eye lens and the condenser lens 15 so as to be the line illumination Ex1.

Similarly, the laser beam emitted from the excitation light source L2 and the laser beam emitted from the excitation light source L4 are made coaxial by the dichroic mirrors 13b and 13c, and form a line illumination so as to be the line illumination Ex2 having an axis different from that of the line illumination Ex1. The line illuminations Ex1 and Ex2 form line illuminations on different axes (a primary image) separated by Δy in the incident slit 16 (slit conjugate) having a plurality of slit portions through which the line illuminations Ex1 and Ex2 can pass, respectively.

The primary image is projected on the sample S on the stage 20 through the observation optical system 40. The observation optical system 40 includes a condenser lens 41, dichroic mirrors 42 and 43, an objective lens 44, a band-pass filter 45, and a condenser lens 46. The line illuminations Ex1 and Ex2 are collimated by the condenser lens 41 paired with the objective lens 44, reflected by the dichroic mirrors 42 and 43, transmitted through the objective lens 44, and applied to the sample S.

The illuminations as illustrated in FIG. 6 are formed on the surface of the sample S. The fluorescence excited by these illuminations is condensed by the objective lens 44, reflected by the dichroic mirror 43, transmitted through the dichroic mirror 42 and the band-pass filter 45 that cuts off the excitation light, condensed again by the condenser lens 46, and incident on the spectral imaging section 30.

The spectral imaging section 30 includes the observation slit 31, the imaging element 32 (32a, 32b), a first prism 33, a mirror 34, a diffraction grating 35 (wavelength dispersion element), and a second prism 36.

The observation slit 31 is disposed at the condensing point of the condenser lens 46 and has as many slit portions as the number of excitation lines. The fluorescence spectra derived from the two excitation lines that have passed through the observation slit 31 are separated by the first prism 33 and reflected by the grating surfaces of the diffraction gratings 35 via the mirrors 34, so that the fluorescence spectra are further separated into fluorescence spectra of respective excitation wavelengths. The four fluorescence spectra thus separated are incident on the imaging elements 32a and 32b via the mirrors 34 and the second prism 36, and provided as (x, λ) information that is spectral data.

The pixel size (nm/Pixel) of the imaging elements 32a and 32b is not particularly limited, and is set to, for example, 2 nm or more and 20 nm or less. This dispersion value may be realized optically or at a pitch of the diffraction grating 35, or may be realized by using hardware binning of the imaging elements 32a and 32b.

The stage 20 and the scanning mechanism 50 constitute an X-Y stage, and move the sample S in the X-axis direction and the Y-axis direction in order to acquire a fluorescence image of the sample S. In whole slide imaging (WSI), an operation of scanning the sample S in the Y-axis direction, then moving the sample S in the X-axis direction, and further performing scanning in the Y-axis direction is repeated (see FIG. 10).

The non-fluorescence observation section 70 includes a light source 71, the dichroic mirror 43, the objective lens 44, a condenser lens 72, an imaging element 73, and the like. In the non-fluorescence observation system, FIG. 4 illustrates an observation system by dark field illumination.

The light source 71 is disposed below the stage 20, and irradiates the sample S on the stage 20 with illumination light from the side opposite to the line illuminations Ex1 and Ex2. In the case of dark field illumination, the light source 71 applies illumination from the outside of the numerical aperture (NA) of the objective lens 44, and the light (dark field image) diffracted by the sample S is imaged by the imaging element 73 via the objective lens 44, the dichroic mirror 43, and the condenser lens 72. By using dark field illumination, even an apparently transparent sample such as a fluorescently-stained sample can be observed with contrast.

Note that this dark field image may be observed simultaneously with fluorescence and used for real-time focusing. In this case, as the illumination wavelength, it is only required to select a wavelength that does not affect fluorescence observation. The non-fluorescence observation section 70 is not limited to an observation system that acquires a dark field image, and may be configured by an observation system that can acquire a non-fluorescence image such as a bright field image, a phase difference image, a phase image, and an in-line hologram image. For example, as a method for acquiring a non-fluorescence image, various observation methods such as a Schlieren method, a phase difference contrast method, a polarization observation method, and an epi-illumination method can be employed. The position of the illumination light source is not limited to a position below the stage, and may be located above the stage or around the objective lens. Furthermore, not only a method of performing focus control in real time, but also another method such as a pre-focus map method of recording a focus coordinate (Z coordinate) in advance may be adopted.

### Technology Applicable to Embodiment of Present Disclosure

Next, a technology applicable to the embodiment of the present disclosure will be described.

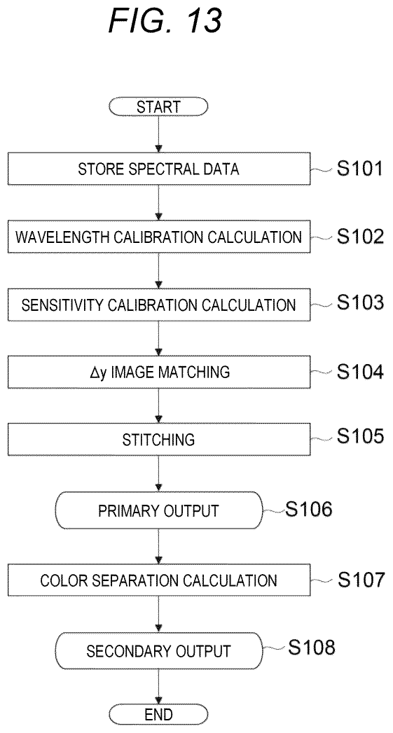

FIG. 13 is a flowchart illustrating an example of a procedure of processing executed in the information processing device (processing unit) 2. Note that details of the gradation processing section 24 (see FIG. 3) will be described later.

The storage section 21 stores the spectral data (fluorescence spectra Fs1, Fs2 (See FIGS. 7 and 8)) acquired by the spectral imaging section 30. (step 101). In the storage section 21, autofluorescence related to the sample S and a standard spectrum of a single dye are stored in advance.

The storage section 21 improves the recording frame rate by extracting only the wavelength region of interest from the pixel array in the wavelength direction of the imaging element 32. The wavelength region of interest corresponds to, for example, a range of visible light (380 nm to 780 nm) or a wavelength range determined by emission wavelengths of the dyes that stain the sample.

Examples of the wavelength region other than the wavelength region of interest include a sensor region having light of an unnecessary wavelength, a sensor region having obviously no signal, and a region of an excitation wavelength to be cut by the dichroic mirror 42 or the band-pass filter 45 in the middle of the optical path. Moreover, the wavelength region of interest on the sensor may be switched depending on the situation of the line illumination. For example, when there are a few excitation wavelengths used for the line illumination, the wavelength region on the sensor is also limited, and the frame rate can be increased by the limited amount.

A data calibrating section 22 converts the spectral data stored in the storage section 21 from pixel data (x, λ) into a wavelength, and performs calibration so that all the pieces of spectral data are complemented such that they are in units of wavelengths ([nm], [μm], or the like) and have a common discrete value, and are output (step 102).

The pixel data (x, λ) is not necessarily neatly aligned in the pixel column of the imaging element 32, and is distorted due to slight inclination or distortion of the optical system is some cases. Therefore, for example, if pixels are converted into wavelength units by using a light source having a known wavelength, the pixels are converted into different wavelengths (nm values) in all x coordinates. In this state, since handling of data is complicated, the data is transformed into data aligned with integers by a complementation method (for example, linear complementation or spline complementation) (step 102).

Moreover, sensitivity unevenness occurs in the long axis direction (X-axis direction) of the line illumination. The sensitivity unevenness is generated by unevenness of the illumination or a variation in the slit width, which leads to luminance unevenness of a captured image. Therefore, in order to eliminate the unevenness, the data calibrating section 22 uniformizes and outputs the sensitivity by using an arbitrary light source and its representative spectrum (average spectrum or spectral radiance of the light source) (step 103). By making the sensitivity uniform, there is no instrumental error, and in the waveform analysis of a spectrum, it is possible to reduce time and effort for measuring each component spectrum every time. Moreover, an approximate quantitative value of the number of fluorescent dyes can also be output from the luminance value subjected to sensitivity calibration.

If the spectral radiance [W/(sr·m 2·nm)] is adopted to the calibrated spectrum, the sensitivity of the imaging element 32 corresponding to each wavelength is also corrected. In this way, by performing calibration such that adjustment to a spectrum used as a reference is performed, it is not necessary to measure the reference spectrum used for color separation calculation for each instrument. In the case of a dye stable in the same lot, data obtained by performing imaging once can be re-used. Moreover, if the fluorescence spectrum intensity per molecule of dye is given in advance, an approximate value of the number of fluorescent dye molecules converted from the luminance value subjected to sensitivity calibration can be output. This value is high in quantitativity because autofluorescence components are also separated.

The above processing is similarly executed for the illumination range by the line illuminations Ex1 and Ex2 in the sample S scanned in the Y-axis direction. Therefore, spectral data (x, y, λ) of each fluorescence spectrum is obtained for the entire range of the sample S. The obtained spectral data (x, y, λ) is stored in the storage section 21.

The image forming section 23 forms a fluorescence image of the sample S on the basis of the spectral data stored in the storage section 21 (or the spectral data calibrated by the data calibrating section 22) and the interval corresponding to the inter-axis distance (Δy) of the excitation lines Ex1 and Ex2 (step 104). In the present embodiment, the image forming section 23 forms, as a fluorescence image, an image in which the detection coordinates of the imaging element 32 are corrected with a value corresponding to the interval (Δy) between the plurality of line illuminations Ex1 and Ex2.

Since the three-dimensional data derived from each of the line illuminations Ex1 and Ex2 is data whose coordinates are shifted by Δy with respect to the Y axis, the three-dimensional data is corrected and output on the basis of Δy recorded in advance or a value of Δy calculated from the output of the imaging element 32. Here, the difference in detection coordinates in the imaging element 32 is corrected so that the three-dimensional data derived from each of the line illuminations Ex1 and Ex2 is data on the same coordinates.

The image forming section 23 executes processing (stitching) for connecting captured images to form one large image (WSI) (step 105). Therefore, it is possible to acquire a pathological image regarding the multiplexed sample S (observation target Sa). The formed fluorescence image is output to the display section 3 (step 106).

Moreover, the image forming section 23 separates and calculates the component distributions of the autofluorescence and the dyes of the sample S from the imaged spectral data (measurement spectrum) on the basis of the standard spectra of the autofluorescence and single dyes of the sample S stored in advance in the storage section 21. As a calculation method, a least squares method, a weighted least squares method, or the like can be employed, and a coefficient is calculated such that captured spectral data is a linear sum of the standard spectra described above. The distribution of the calculated coefficients is stored in the storage section 21, is output to the display section 3, and displayed as an image (steps 107 and 108).

As described above, according to the present embodiment, it is possible to provide a multiple fluorescence scanner in which the imaging time does not increase even if the number of dyes which are observation targets increases.

### Embodiment of Present Disclosure

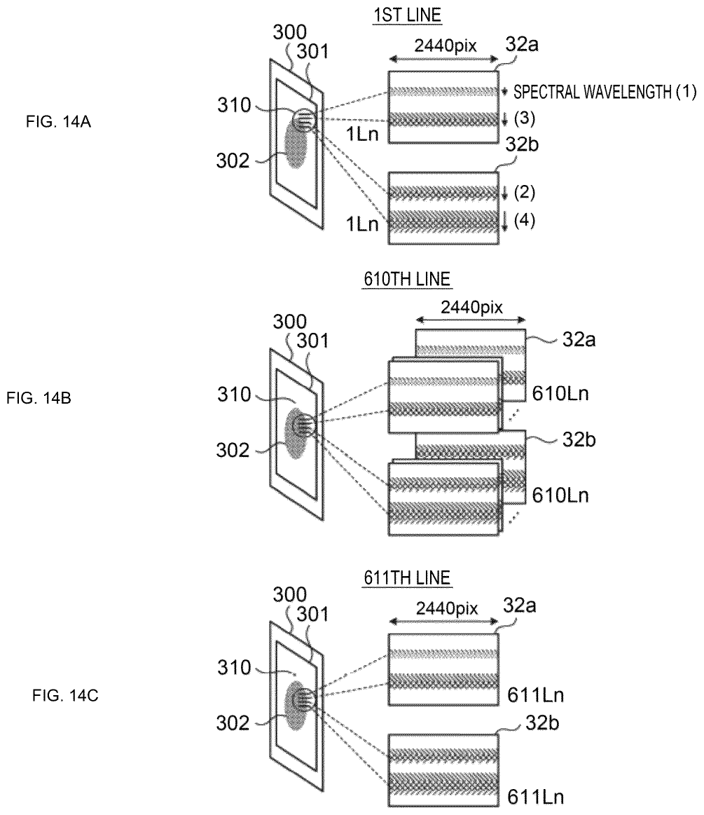

FIG. 14 is a view schematically illustrating a flow of spectral data (x, λ) acquisition processing according to the embodiment. Hereinafter, the configuration example 2 of FIG. 10 is applied as a configuration example of a combination of line illuminations and excitation light using the two imaging elements 32a and 32b. It is assumed that the imaging element 32a acquires spectral data (x, λ) corresponding to the excitation wavelengths λ=405 [nm] and 532 [nm] by the line illumination Ex1, and that the imaging element 32b acquires spectral data (x, λ) corresponding to the excitation wavelengths λ=488 [nm] and 638 [nm] by the line illumination Ex2. Furthermore, it is assumed that the number of pixels corresponding to one line of scanning is set to 2440 [pix], and the scan position is moved in the X-axis direction for each scan of 610 lines in the Y-axis direction.

Section (a) in FIG. 14 illustrates an example of spectral data (x, λ) acquired in the first line of scan (also described as “1Ln” in the drawing). A tissue 302 corresponding to the sample S described above is fixed by being sandwiched between a slide glass 300 and a cover glass 301, and is placed on the sample stage 20 with the slide glass 300 as a lower surface. A region 310 in the drawing indicates an area irradiated with four laser beams (excitation light) by the line illuminations Ex1 and Ex2.

Furthermore, in the imaging elements 32a and 32b, the horizontal direction (row direction) in the drawing indicates the position in the scan line, and the vertical direction (column direction) indicates the wavelength.

In the imaging element 32a, a plurality of fluorescence images (spectral data (x, λ)) corresponding to the spectral wavelengths (1) and (3) corresponding to the excitation wavelengths λ=405 [nm] and 532 [nm], respectively, is acquired. For example, in the example of the spectral wavelength (1), each spectral data (x, λ) acquired here includes data (luminance value) of a predetermined wavelength region (referred to as a spectral wavelength region as appropriate) including the maximum value of the fluorescence intensity corresponding to the excitation wavelength λ=405 [nm].

Each spectral data (x, λ) is associated with a position in the column direction of the imaging element 32a. At this time, the wavelength λ may not be continuous in the column direction of the imaging element 32a. That is, the wavelength of the spectral data (x, λ) at the spectral wavelength (1) and the wavelength of the spectral data (x, λ) at the spectral wavelength (3) may not be continuous including a blank portion therebetween.

Similarly, in the imaging element 32b, spectral data (x, λ) at the spectral wavelengths (2) and (4) at the excitation wavelengths λ=488 [nm] and 638 [nm], respectively, is acquired. Here, in the example of the spectral wavelength (1), each spectral data (x, λ) includes data (luminance value) of a predetermined wavelength region including the maximum value of the fluorescence intensity corresponding to the excitation wavelength λ=405 [nm].

Here, as described with reference to FIGS. 4 and 6, in the imaging elements 32a and 32b, data in the wavelength region of each spectral data (x, λ) is selectively read, and data in other regions (indicated as blank portions in the drawing) is not read. For example, in the example of the imaging element 32a, spectral data (x, λ) in the wavelength region of the spectral wavelength (1) and spectral data (x, λ) in the wavelength region of the spectral wavelength (3) are acquired. The acquired spectral data (x, λ) of each wavelength region is stored in the storage section 21 as each spectral data (x, λ) of the first line.

Section (b) in FIG. 14 illustrates an example of a case where scan up to the 610th line (also referred to as “610Ln” in the drawing) is completed at the same scan position as section (a) in the X-axis direction. At this time, the spectral data (x, λ) of the wavelength region of each of the spectral wavelengths (1) to (4) for 610 lines is stored in the storage section 21 for each line. When reading of the 610 lines and storage of them in the storage section 21 are completed, scan of the 611th line (also referred to as “611Ln” in the drawing) is performed as illustrated in section (c) of FIG. 14. In this example, scan of the 611th line is executed by moving the position of the scan in the X-axis direction and, for example, resetting the position of the scan in the Y-axis direction.

### Example of Acquired Data and Rearrangement of Data

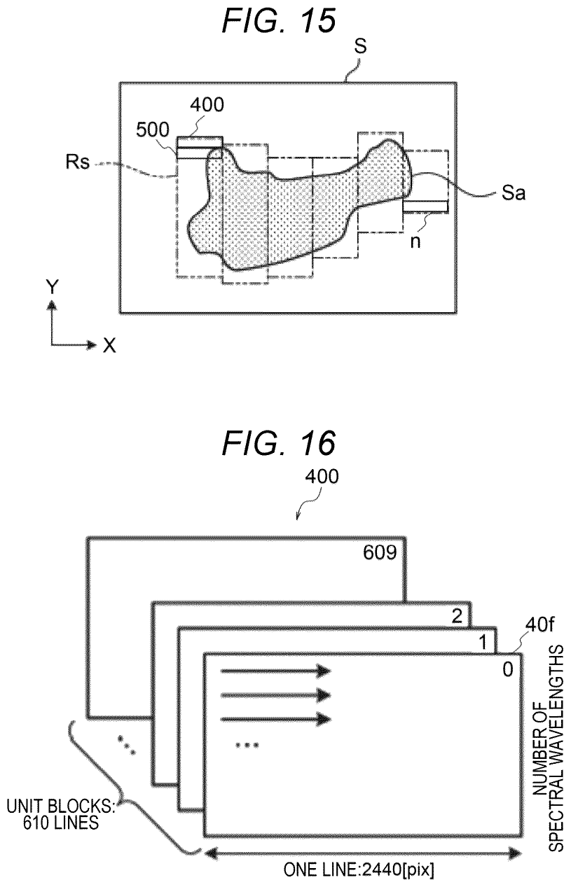

FIG. 15 is a view schematically illustrating a plurality of unit blocks 400, 500. As described above, the imaging region Rs is divided into a plurality of regions in the X-axis direction, and an operation of scanning the sample S in the Y-axis direction, then moving in the X-axis direction, and further performing scanning in the Y-axis direction is repeated. The imaging region Rs further includes a plurality of unit blocks 400 and 500. For example, data for 610 lines illustrated in section (b) of FIG. 14 is referred to as a unit block as a basic unit.

Next, acquired data and rearrangement of data according to the embodiment will be described. FIG. 16 is a schematic view illustrating an example of spectral data (x, λ) stored in the storage section 21 at the time when scan of the 610th line illustrated in section (b) of FIG. 14 is completed. As illustrated in FIG. 16, the spectral data (x, λ) indicates a position on the line in the horizontal direction in the drawing for each scan line, and a block indicating the number of spectral wavelengths in the vertical direction in the drawing is stored as a frame 40f in the storage section 21. Then, the unit block 400 (see FIG. 15) is formed by the frame 40f for 610 lines.

Note that, in FIG. 16 and the following similar drawings, an arrow in the frame 40f indicates a direction of memory access in the storage section 21 in a case where C language, which is one of programming languages or a language conforming to C language is used for access to the storage section 21. In the example of FIG. 16, access is made in the horizontal direction (that is, the line position direction) of the frame 40f, and this is repeated in the vertical direction (that is, the direction of the number of spectral wavelengths) of the frame 40f.

Note that the number of spectral wavelengths corresponds to the number of channels in a case where the spectral wavelength region is divided into a plurality of channels.

In the embodiment, the information processing device 2 converts the arrangement order of the spectral data (x, λ) of each wavelength region stored for each line into the arrangement order for each of the spectral wavelengths (1) to (4) by the image forming section 23, for example.

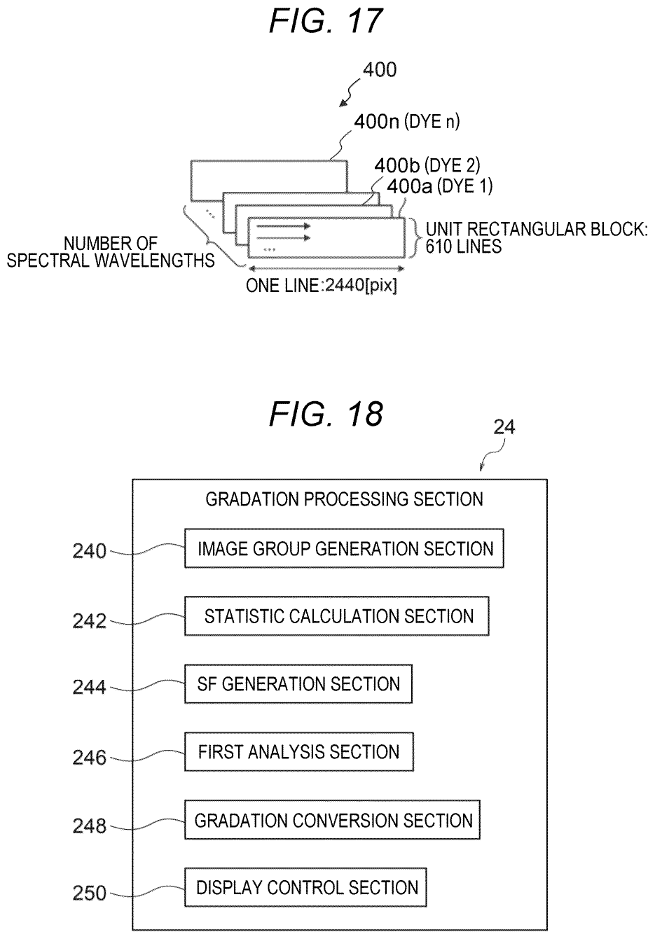

FIG. 17 is a schematic view illustrating an example of spectral data (x, λ) in which an arrangement order of data is changed according to the embodiment. As illustrated in FIG. 17, the spectral data (x, λ) is stored in the storage section 21 such that arrangement order of the data is converted into the arrangement order indicating the position on the line in the horizontal direction in the drawing and the scan line in the vertical direction in the drawing for each spectral wavelength. Here, frames 400a, 400b, . . . 400n corresponding to the respective dyes 1 . . . and including 2440 [pix] in the horizontal direction and 610 lines in the vertical direction in the drawing are referred to as unit rectangular blocks in the present embodiment.

In the arrangement order of the data in the unit rectangular blocks according to the embodiment illustrated in FIG. 17, the array of the pixels in the frames 400a, 400b, . . . 400n corresponds to the two-dimensional information in the unit block 400 in the tissue 302 on the slide glass 300. Therefore, the unit rectangular blocks 400a, 400b, . . . 400n according to the embodiment enable spectral data (x, λ) of the tissue 302 to be directly handled as two-dimensional information in the unit block 400 for the tissue 302 as compared with the frame 40f illustrated in FIG. 16. Therefore, by applying the information processing device 2 according to the embodiment, it is possible to more easily and quickly perform image processing, optical spectral waveform separation processing (color separation processing), and the like on captured image data acquired by the line spectrometer (observation unit 1).

FIG. 18 is a block diagram illustrating a configuration example of the gradation processing section 24 according to the present embodiment. As illustrated in FIG. 18, the gradation processing section 24 includes an image group generation section 240, a statistic calculation section 242, a scaling factor (SF) generation section 244, a first analysis section 246, a gradation conversion section 248, and a display control section 250. Note that in the present embodiment, two-dimensional information displayed on the display section 3 is referred to as an image or the range of the two-dimensional information is referred to as an image, and data used to display the image is referred to as image data or simply data. Furthermore, the image data according to the present embodiment is a numerical value related to at least one of a luminance value or an output value in units of the number of antibodies.

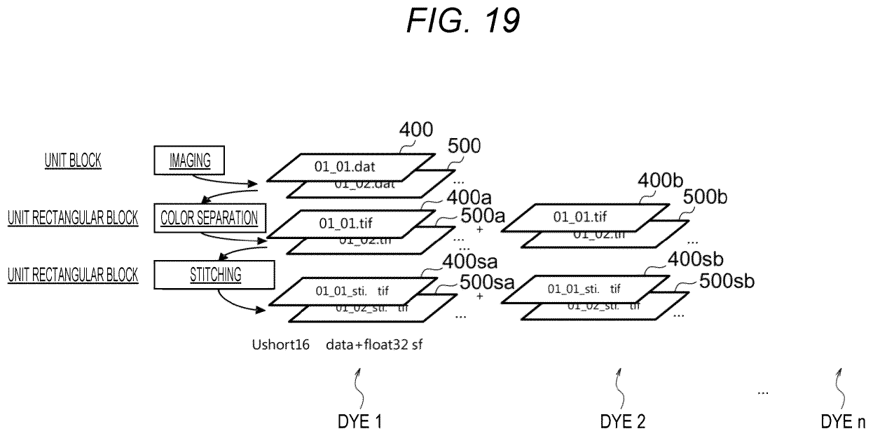

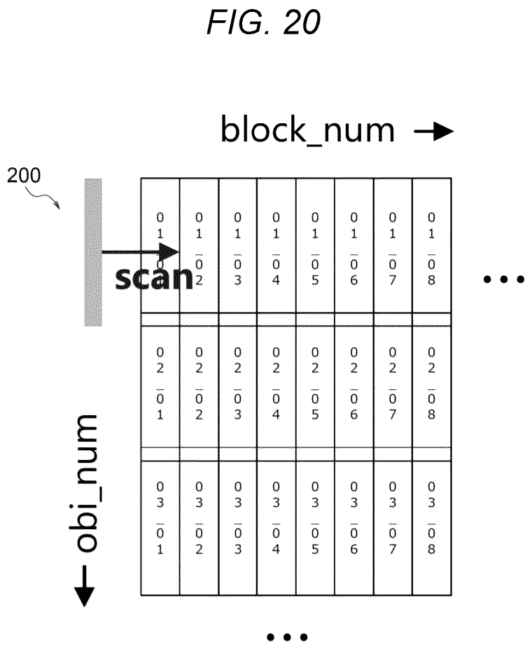

Here, processing in the gradation processing section 24 will be described with reference to FIGS. 19 to 21. FIG. 19 is a diagram conceptually describing a processing example of the gradation processing section 24 according to the present embodiment. FIG. 20 is a diagram illustrating an example of a data name corresponding to an imaging position. As illustrated in FIG. 20, for example, a data name is allocated correspondingly to a region 200 of the unit block. Therefore, for example, a data name corresponding to two-dimensional position in the row direction (block_num) and the column direction (obi_num) can be allocated to imaging data for each unit block.

Again, as illustrated in FIG. 19, first, all pieces of the imaging data (see FIGS. 15 and 16) for each of the imaged unit blocks 400, 500, . . . n is called from the storage section 21 to the image forming section 23. As illustrated in FIG. 20, according to the imaging positions of each of the unit blocks 400, 500, . . . n, for example, 01_01. dat is allocated to the data corresponding to the unit block 400 and 01_02.dat is allocated to the data corresponding to the unit block 500. Although only the unit blocks 400 and 500 are illustrated in FIG. 19 to simplify the description, the unit blocks 400, 500, . . . n are processed.

As illustrated in FIG. 19, next, the imaging data 01_01.dat of the unit block 400 is subjected to the color separation processing by image forming section 23 as described above, and is separated into the unit rectangular blocks 400a, 400b, . . . 400n (see FIG. 17). Similarly, the imaging data 01_02.dat of the unit block 500 is subjected to the color separation processing by image forming section 23, and is separated into the unit rectangular blocks 500a, 500b, . . . 500n. In this manner, the imaging data for each of all the unit blocks is separated into the unit rectangular blocks corresponding to the dyes by the color separation processing. Then, a data name is allocated to the data of each unit rectangular block according to the rule illustrated in FIG. 20.

Next, the image forming section 23 performs, on the unit rectangular blocks 400a, 400b, . . . stitch processing for connecting captured images to form one large stitch image (WSI).

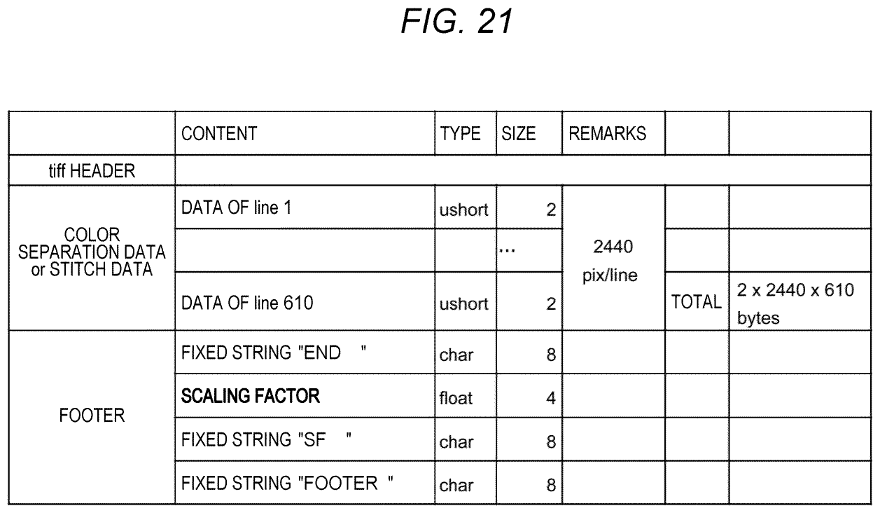

Next, the image group generation section 240 subdivides each piece of data subjected to the stitching processing and subjected to the color separation processing into minimum sections, and generates a mipmap (MIPmap). Data names are allocated to these minimum sections according to the rule illustrated in FIG. 20. Note that, in FIG. 19, calculation is performed by setting the minimum sections of the stitch-processed image as unit blocks 400sa, 400sb, 500sa, and 500sb, but the present invention is not limited thereto. For example, as illustrated in FIGS. 20 and 21 to be described later, the image may be redivided into square regions, for example. Note that, in the present embodiment, in texture filtering of three-dimensional computer graphics, an image group pre-calculated so as to complement a main texture image is referred to as a mipmap. Details of the mipmap will be described later with reference to FIGS. 20 and 21.

The statistic calculation section 242 calculates a statistic Stv for the image data (luminance data) in each of the unit rectangular block unit blocks 400sa, 400sb, 500sa, and 500sb. The statistic Stv is a maximum value, a minimum value, an intermediate value, a mode value, or the like. The image data is, for example, float32, and is, for example, 32 bits.

The SF generation section 242 uses the statistic Stv calculated by the statistic calculation section 242 to calculate a scaling factor (Sf) for each of the unit rectangular blocks 400sa, 400sb, 500sa, 500sb. Then, the SF generation section 242 stores the scaling factor (Sf) in the storage section 21.

The scaling factor Sf is a value obtained by dividing, for example, a difference between the maximum value maxv and the minimum value minv of the image data (luminance data) in each of the unit rectangular blocks 400sa, 400sb, 500sa, 500sb, . . . by a data size dsz, for example, as expressed in Formula (1). A pixel value range serving as a reference when a dynamic range is adjusted is, for example, the data size dsz, a value of ushort16 (0-65535)=2¹⁶-1, and 16 bits. The data size of the original image data is 32 bits of float32. Note that in the present embodiment, the image data before being divided by the scaling factor Sf is referred to as original image data. As described above, the original image data has a 32-bit data size of float32. This data size corresponds to a pixel value.

As a result, for example, the scaling factor Sf of a region with strong fluorescence is calculated as 5 or the like, and the scaling factor Sf of a region without fluorescence is calculated as 0.1 or the like. In other words, the scaling factor Sf corresponds to the dynamic range in the original image data of each of the unit rectangular blocks 400sa, 400sb, 500sa, 500sb, . . . . In the following description, the minimum value minv is set to 0, but the present invention is not limited thereto. Note that the scaling factor according to the present embodiment corresponds to the first value.

$$\begin{matrix}[ Mathematical formula 1 ] & \\ Sf = ( max v - min v ) / dsz & Formula ( 1 )\end{matrix}$$

The first analysis section 246 extracts a subject region from the image. Then, the statistic calculation section 242 calculates the statistic Stv by using the original image data in the subject region, and the SF generation section 242 calculates the scaling factor Sf on the basis of the statistic Stv.

The gradation conversion section 248 divides the original image data of each of the unit rectangular blocks 400sa, 400sb, 500sa, 500sb, . . . by the scaling factor Sf, and stores the divided data in the storage section 21. As can be seen from these, the first image data processed by the gradation conversion section 248 is normalized by a pixel value range that is a difference between the maximum value maxv and the minimum value minv. Note that in the present embodiment, the image data obtained by dividing the pixel value of the original image data by the scaling factor Sf is referred to as first image data. The first image data has a data format of, for example, ushort16.

That is, in a case where the scaling factor Sf is greater than 1, the dynamic range of second image data is compressed, and in a case where the scaling factor Sf is smaller than 1, the dynamic range of the second image data is expanded. In contrast, when the first image data processed by the gradation conversion section 248 is multiplied by the corresponding scaling factor Sf, the original pixel value of the original image data can be obtained. The scaling factor Sf is, for example, float32, and is 32 bits.

Similarly, for the unit rectangular blocks 400a, 400b, which are color separation data, the scaling factor Sf calculates the scaling factor Sf, and the gradation conversion section 248 performs gradation conversion on the original image data by the scaling factor Sf to generate first image data.

FIG. 21 is a diagram illustrating an example of a data format of each of the unit rectangular blocks 400sa, 400sb, 500sa, 500sb The data of each of the unit rectangular blocks 400sa, 400sb, 500sa, 500sb . . . is stored in the storage section 21 in, for example, a tagged image file format (Tiff) format. Each piece of the image data is converted from float 32 to 16 bits of ushort16, and the storage capacity is compressed. Similarly, the data of each of the unit rectangular blocks 400a, 400b . . . is stored in the storage section 21 in, for example, a tagged image file format (Tiff) format. Each piece of the original image data is converted from float32 to first image data of ushort16, and the storage capacity is compressed. Since the scaling factor Sf is recorded in the footer, the scaling factor Sf can be read from the storage section 21 without reading the image data.

In this manner, the first image data obtained by division by the scaling factor Sf and the scaling factor Sf are stored in the storage section 21 in association with each other, for example, in the Tiff format. Therefore, the first image data is compressed from 32 bits to 16 bits. Since the dynamic range of the first image data is adjusted, all images can be visualized in a case where the first image data is displayed on the display section 3. In contrast, if the first image data is multiplied by the corresponding scaling factor Sf, the pixel value of the original image data can be obtained, and the amount of information is also maintained.

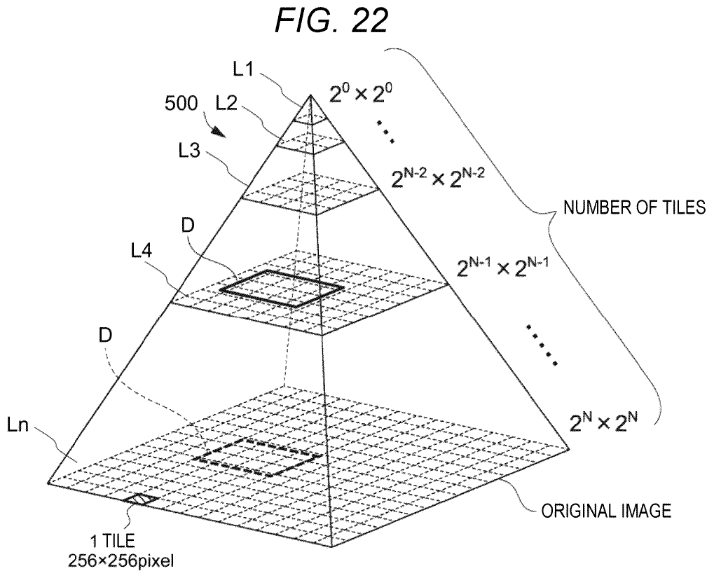

Here, a processing example of the image group generation section 240 will be described with reference to FIG. 22. FIG. 22 is a view illustrating an image pyramid structure for explaining a processing example of the image group generation section 240. The image group generation section 240 generates an image pyramid structure 500 by using, for example, a stitching image (WSI).

The image pyramid structure 500 is an image group generated with a plurality of different resolutions from that of the stitching image (WSI) obtained by the image forming section 23 synthesizing the unit rectangular blocks 400a, 500a, . . . for each dye by the stitching processing. An image having the largest size is arranged at the lowermost Ln of the image pyramid structure 500, and an image having the smallest size is arranged at the uppermost L1. The resolution of the image having the largest size is, for example, 50×50 (Kpixels: kilo pixels) or 40×60 (Kpixels). The image having the smallest size is, for example, 256×256 (pixels) or 256×512 (pixels). In the present embodiment, one tile, which is a constituent region of an image region is referred to as a unit region image. Note that the unit region image may have any size and shape.

That is, if the same display section 3 displays these images at, for example, 100% (displays each image with the same number of physical dots as the number of pixels of the image), an image Ln having the largest size is displayed at the largest size, and an image L1 having the smallest size is displayed at the smallest size. Here, in FIG. 22, the display range of the display section 106 is indicated as D. Note that the entire image group forming the image pyramid structure 50 may be generated by a known compression method, or may be generated by a known compression method used when a thumbnail image is generated, for example.

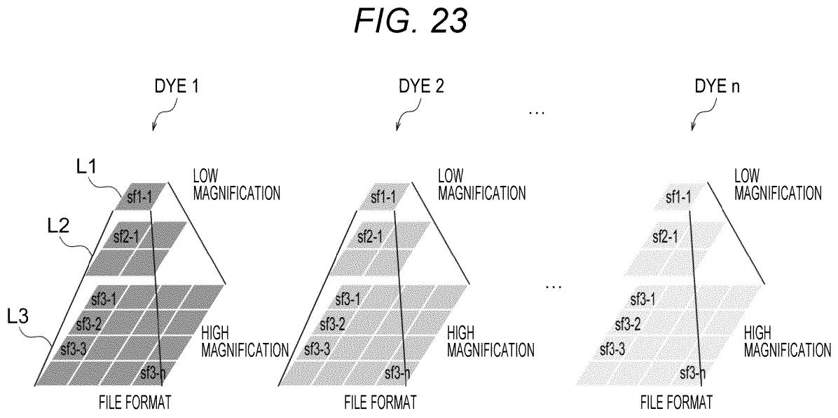

FIG. 23 is a view illustrating an example in which stitching images (WSIs) of the wavelength bands of the dyes 1 to n of FIG. 19 are regenerated as image pyramid structures. That is, FIG. 23 is a view illustrating an example in which the image group generation section 240 regenerates a stitching image (WSI) for each dye generated by the image forming section 23 as an image pyramid structure. For the sake of simplicity, three levels are illustrated, but the present invention is not limited thereto. In the image pyramid structure of the dye 1, for example, scaling factors Sf3-1 to Sf3-n are associated as Tiff data with the unit region images at the L3 level, respectively, and the pixel value of the original image data of each unit region image is converted into first image data by the gradation conversion section 248. Similarly, for example, scaling factors Sf2-1 to Sf2-n are associated as Tiff data with the small images at the L2 level, respectively, and the pixel value of each piece of the first image data is converted into first image data by the gradation conversion section 248. Similarly, for example, a scaling factor Sf1 is associated as Tiff data with the small image at the L1 level, and the pixel value of the original image data is converted into first image data by the gradation conversion section 248. Similar processing is performed on the stitching images in the wavelength bands of the dyes 2 to n. Then, the data of the image pyramid structures is stored in the storage section 21 in, for example, a tagged image file format (Tiff) format as a mipmap.

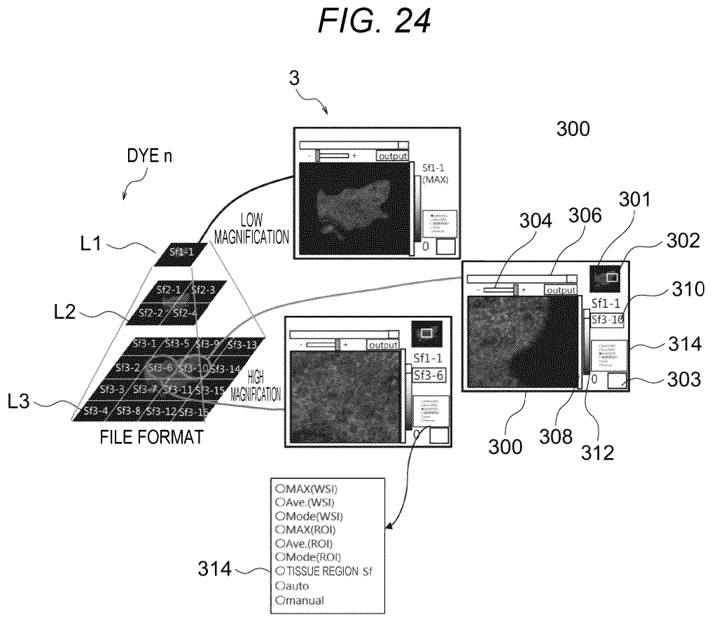

FIG. 24 is an example of a display screen generated by the display control section 250. A main observation image in which the dynamic range is adjusted on the basis of the scaling factor Sf is displayed in a display region 3000. In a thumbnail image region 3010, an entire image of the observation range is displayed. A region 3020 indicates a displayed range of the display region 3000 in the entire image (thumbnail image). In the thumbnail image region 3010, for example, a non-fluorescence observation section (camera) image captured by the imaging element 73 may be displayed.

A selected wavelength operation region section 3030 is an input section that inputs a wavelength range of the display image, for example, wavelengths corresponding to the dyes 1 to n, in accordance with an instruction from an operation section 4. A magnification operation region section 3040 is an input section that inputs a value for changing the display magnification in accordance with an instruction from the operation section 4. A horizontal operation region section 3060 is an input section that inputs a value for changing the horizontal direction selection position of the image in accordance with an instruction from the operation section 4. A vertical operation region section 3080 is an input section that inputs a value for changing the vertical direction selection position of the image in accordance with an instruction from the operation section 4. A display region 3100 displays the scaling factor Sf of the main observation image. A display region 3120 is an input section that selects a value of the scaling factor in accordance with an instruction from the operation section 4. The value of the scaling factor corresponds to the dynamic range as described above. For example, the value corresponds to the maximum value maxv (see Formula 1) of the pixel value. A display region 3140 is an input section that selects an arithmetic algorithm of the scaling factor Sf in accordance with an instruction from the operation section 4. Note that the display control section 250 may further display a file path of an observation image, an entire image, or the like.

The display control section 250 calls the mipmap image of the corresponding dye n from the storage section 21 by an input in the selected wavelength operation region section 3030. In this case, the mipmap image of the dye n generated according to the arithmetic algorithm corresponding to the display region 3140 to be described later is read.

The display control section 250 displays an image at level L1 in a case where the instruction input in the magnification operation region section 3040 is less than a first threshold, displays an image at level L2 in a case where the instruction input is the first threshold or more, and displays an image at level L3 in a case where the instruction input is the second threshold or more.

The display control section 250 displays, in the display region 3000, the display region D (see FIG. 22) selected by the horizontal operation region section 3060 and the vertical operation region section 3080 as the main observation image. In this case, the pixel value of the image data of each unit region image is recalculated by the gradation conversion section 248 with the scaling factor Sf associated with each unit region image included in the display region D.

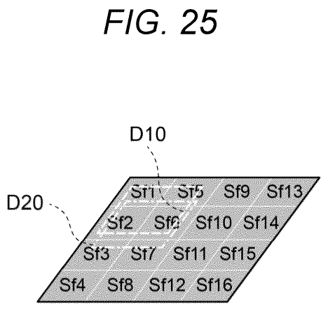

FIG. 25 is a diagram illustrating an example in which the display region D is changed from D10 to D20 by input processing via the horizontal operation region section 3060 and the vertical operation region section 3080.

First, in a case where the region D10 is selected, the gradation conversion section 248 reads the scaling factors Sf1, Sf2, SF5, and Sf6 stored in association with the respective unit region images from the storage section 21. Then, as expressed in Formula (2), pieces of the image data of the unit region images are multiplied by the corresponding scaling factors Sf1, Sf2, SF5, and Sf6, respectively, and obtained values are divided by the maximum value MAX_Sf (1, 2, 5, 6) of the scaling factors.

$$Pixel value after rescaling = ( each Sf \times pixel value before rescaling ) / MAX\_Sf ( 1 , 2 , 5 , 6 ) \qquad Formula ( 2 )$$

Pieces of the first image data of the unit region images is multiplied by the corresponding scaling factors Sf1, Sf2, SF5, and Sf6, respectively, to be converted into pixel values in the original image data. Then, the pixel values are divided by the maximum value MAX_Sf (1, 2, 5, 6) of the scaling factors and therefore the image data of the region D10 is normalized. Therefore, the luminance of the image data of the region D10 is more appropriately displayed. For example, in a case where the scaling factor Sf is calculated by the above-described Formula (1), the value of the image data of each unit region image is normalized between the maximum value and the minimum value in the original image data of each unit region image included in the region D10. As described above, the dynamic range of the first image data in the region D10 is readjusted by using the scaling factors Sf1, Sf2, SF5, and Sf6, and all the pieces of the first image data in the region D10 can be visually recognized. As can be seen from these, recalculation of the statistic calculation section 242 becomes unnecessary, and the dynamic range can be adjusted in a shorter time according to region conversion.

Furthermore, the display control section 250 displays the maximum value MAX_Sf (1, 2, 5, 6) in the display region 3100. Therefore, the operator can more easily recognize how much the dynamic range is compressed or expanded.

Next, in a case where the region is changed to the region D20, the scaling factors Sf1, Sf2, SF5, Sf6, and Sf7 stored in association with the respective unit region images are read from the storage section 21. Then, as expressed in Formula (3), pieces of the first image data of the unit region images are multiplied by the corresponding scaling factors Sf1, Sf2, SF5, Sf6, and Sf7 respectively, and obtained values are divided by the maximum value MAX_Sf (1, 2, 5, 6, 7) of the scaling factors.

$$Pixel value after rescaling = ( each Sf \times pixel value before rescaling ) / MAX\_Sf ( 1 , 2 , 5 , 6 , 7 ) \qquad Formula ( 3 )$$

Pieces of the first image data of the unit region images are multiplied by the corresponding scaling factors Sf1, Sf2, SF5, Sf6, and Sf7, respectively to be converted into pixel values of the original image data. Then, the pixel values are divided by the maximum value MAX_Sf (1, 2, 5, 6, 7) of the scaling factors to normalize the first image data of the region D20 again. Therefore, the luminance of the image data of the region D10 is more appropriately displayed. Similarly to the above, the display control section 250 displays the maximum value MAX_Sf (1, 2, 5, 6, 7) in the display region 3100. Therefore, the operator can more easily recognize how much the dynamic range is compressed or expanded.

In a case where a manual is selected as an arithmetic algorithm corresponding to the display region 3140 to be described later, the display control section 250 performs recalculation using Formula (4) by using the value of a scaling factor MSf input via the display region 312.

$$Pixel value after rescaling = ( each Sf \times pixel value before rescaling ) / MSf \qquad Formula ( 4 )$$

Similarly to the above, the display control section 250 displays the scaling factor MSf in the display region 3100. Therefore, the operator can more easily recognize how much the dynamic range is compressed or expanded by his/her operation.

As described above, it is assumed that the original image data after color separation and after stitching is output in units of the number of antibodies of float32, for example. As illustrated in FIG. 21, image data of ushort16 (0-65535) and the float32 coefficient (=scaling factor Sf) are separated and stored in the storage section 21 for each basic region image. By separating the image data and the scaling factor Sf and storing them for each basic region image (small image), in a case where a region extending over a plurality of basic region images as illustrated in FIG. 25 is viewed, the display dynamic range can be adjusted by comparing the scaling factors and performing reallocation (=rescaling) to ushort16 (0-65535).

That is, as described above, by separating the image data of ushort16 and the scaling factor of float32, it is possible to demodulate the data to the original data float32 by integration. Furthermore, since an ushort16 image is stored by using the individual scaling factor Sf for each basic region image (small image), the display dynamic range can be readjusted only in a necessary region. Moreover, by adding the scaling factor Sf to the footer of the basic region image (small image), only the scaling factor Sf can be easily referred to, and comparison between the scaling factors Sf becomes easier.

In the display region 312, a stitching image WSI means a level L1 image. ROI means a selected region image. Furthermore, the maximum value MAX means that the statistic used when calculating the scaling factor Sf is the maximum value. Furthermore, the average value Ave means that the statistic used when calculating the scaling factor Sf is the average value. Furthermore, the mode value Mode means that the statistic used when calculating the scaling factor Sf is the mode value. A tissue region Sf means that the scaling factor Sf calculated from a selected image region which is also an image subject region extracted by the first analysis section 246 is used. In this case, for example, the maximum value is used as the statistic.

Therefore, in a case where the maximum value MAX is selected, the mipmap corresponding to the scaling factor Sf generated by using the maximum value by the SF generation section 242 is read from the storage section 21. Similarly, in a case where the average value Ave is selected, the mipmap corresponding to the scaling factor Sf generated by using the average value by the SF generation section 242 is read from the storage section 21. Similarly, in a case where the mode value Mode is selected, the mipmap corresponding to the scaling factor Sf generated by using the mode value by the SF generation section 242 is read from the storage section 21.

That is, a first algorithm (MAX (WSI)) re-converts the pixel values of the display image by the scaling factor LlSf of the level L1 image, as expressed in Formula (5). In this case, the maximum value is used as the scaling factor LlSf. In a case where input processing is performed via the magnification operation region section 3040, the horizontal operation region section 3060, and the vertical operation region section 3080, calculation according to Formula (5) is performed on each unit region image included in the display region. Therefore, an image in any range can be displayed in a uniform dynamic range, and variations in the images can be suppressed.

$$Pixel value after rescaling = ( each Sf \times pixel value before rescaling ) / L 1 Sf \qquad Formula ( 5 )$$

Note that in the following processing, in a case where a WSI-related algorithm is selected in the display region 3100, an image to be displayed may be limited to the level L1 image. In this case, recalculation is unnecessary.

Similarly, a second algorithm (Ave (WSI)) re-converts the pixel values of the display image by the average value L1av of the level L1 image as expressed in Formula (6). Therefore, an image in any range can be displayed in a uniform dynamic range, and variations in the images can be suppressed. Furthermore, in a case where the average value L1av is used, it is possible to observe the information of the entire image while suppressing the information of a fluorescence region, which is a high luminance region. Note that in the following processing, in a case where a WSI-related algorithm is selected in the display region 3100, an image to be displayed may be limited to the level L1 image. In this case, recalculation is unnecessary.

$$Pixel value after rescaling = ( each Sf \times pixel value before rescaling ) / L 1 av \qquad Formula ( 6 )$$

Similarly, a third algorithm (Mode (WSI)) re-converts the pixel values of the display image by the mode value L1mod of the level L1 image as expressed in Formula (7). Therefore, an image in any range can be displayed in a uniform dynamic range, and variations in the images can be suppressed. Furthermore, in a case where the mode value L1mod is used, it is possible to observe information with reference to pixels included most in the image while suppressing information of a fluorescence region, which is a high luminance region. Note that in the following processing, in a case where a WSI-related algorithm is selected in the display region 3100, an image to be displayed may be limited to the level L1 image. In this case, recalculation is unnecessary.

$$Pixel value after rescaling = ( each Sf \times pixel value before rescaling ) / L 1 mod \qquad Formula ( 7 )$$

Similarly, a fourth algorithm ((MAX (ROI)) re-converts the pixel values of the display image by a maximum value ROImax of the scaling factor Sf in the selected basic region image as expressed in Formula (8). In this case, the statistic is the maximum value as described above.

$$Pixel value after rescaling = ( each Sf \times pixel value before rescaling ) / ROI max \qquad Formula ( 8 )$$

Similarly, a fifth algorithm ((Ave (ROI)) re-converts the pixel values of the display image by a maximum value ROIAvemax of the scaling factor Sf in the selected basic region image as expressed in Formula (9). In this case, as described above, the statistic ROIAvemax is an average value.

$$Pixel value after rescaling = ( each Sf \times pixel value before rescaling ) / ROIAve max \qquad Formula ( 9 )$$

Similarly, a sixth algorithm ((Mode (ROI)) re-converts the pixel values of the display image by a maximum value ROIModemax of the scaling factor Sf in the selected basic region image as expressed in Formula (10). In this case, as described above, the statistic ROIModemax is a mode value.

$$Pixel value after rescaling = ( each Sf \times pixel value before rescaling ) / ROIMode max \qquad Formula ( 10 )$$

Similarly, a seventh algorithm (tissue region Sf) re-converts the pixel values of the display image by a maximum value Sfmax of the scaling factor Sf in the selected basic region image as expressed in Formula (11). In this case, as described above, the statistic Sfmax is the maximum value calculated in the image data in the tissue region in each basic region image.

$$Pixel value after rescaling = ( each Sf \times pixel value before rescaling ) / Sf max \qquad Formula ( 11 )$$

Similarly, an eighth algorithm (auto) re-converts the pixel values of the display image by the function Sf (λ) of the representative value λ of the selected wavelength by the input of the selected wavelength operation region section 303 as expressed in Formula (12). This Sf (λ) is a value determined by a past imaging experiment. That is, Sf (λ) is a value according to λ regardless of the captured image. Note that Sf (λ) may be a discrete value determined for each representative value A.

$$Pixel value after rescaling = ( each Sf \times pixel value before rescaling ) / Sf ( λ ) \qquad Formula ( 12 )$$

Similarly, manual, which is a ninth algorithm, is an algorithm for re-converting the pixel values of the display image by using the value of the scaling factor MSf input via the display region 312 as expressed in the above-described Formula (4).

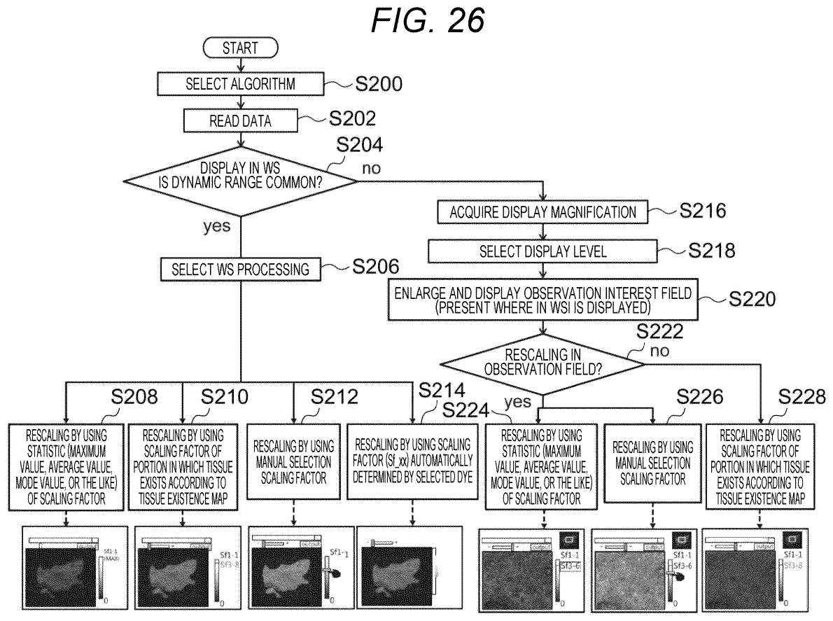

FIG. 26 is a flowchart illustrating a processing example of the information processing device 2. Here, a case will be described in which an image to be displayed is limited to the level L1 image in a case where a WSI related algorithm is selected in the display region 3100.

First, the display control section 250 acquires an algorithm (see FIG. 24) selected by the operator via the display region 3100 (step S200). Subsequently, the display control section 250 reads the mipmap corresponding to the selected algorithm from the storage section 21 (step S202). In this case, in a case where the corresponding mipmap is not stored in the storage section 21, the display control section 250 generates a corresponding mipmap via the image group generation section 240.

Next, the display control section 250 determines whether or not the selected algorithm (see FIG. 24) is related to WSI (step S204). In a case where it is determined to be related to WSI (yes in step S204), the display control section 250 starts processing related to the selected algorithm (step S206).

Subsequently, if the selected algorithm is the first algorithm (MAX (WSI)), the second algorithm (Ave (WSI)), or the third algorithm (Mode (WSI)), the display control section 250 adjusts the dynamic range of the main observation image according to the statistic based on the original image data of the level L1 image (step S208). In this case, since the dynamic range of the first image data of the level L1 image has already been adjusted, recalculation is unnecessary.

Subsequently, if the selected algorithm is the seventh algorithm (tissue region Sf), the display control section 250 adjusts the dynamic range of the main observation image on the basis of the statistic calculated in the image data in the tissue region in the image (step S210). In this case, since the dynamic range of the first image data of the level L1 image has already been adjusted, recalculation is unnecessary.

Subsequently, if the selected algorithm is the ninth algorithm (manual), the display control section 250 re-converts the pixel values of the first image data in the level L1 image, which is the display image by using the value of the scaling factor MSf input via the display region 312 as expressed in the above-described Formula (4) (step S212).

Subsequently, if the selected algorithm is the eighth algorithm (auto), the display control section 250 re-converts the pixel values of the first image data in the level L1 image, which is the display image by the function Sf (λ) of the representative value λ of the selected wavelength by the input of the image selected wavelength operation region section 303.

(step S214)

In contrast, in a case where the display control section 250 determines that the selected algorithm (see FIG. 24) is not related to WSI (no in step S204), the display control section 250 acquires the display magnification input by the operation section 4 via the magnification operation region section 3040 (step S216). The display control section 250 selects one of the image levels L1 to Ln to be used to display the main observation image from the mipmap according to the display magnification (step S218). Subsequently, the display control section 250 displays the display region selected by the horizontal operation region section 3060 and the vertical operation region section 3080 as a frame 302 (see FIG. 24) in a thumbnail image 301 (step S220).

Subsequently, the display control section 250 determines whether or not the selected algorithm (see FIG. 24) is related to the seventh algorithm (tissue region Sf) (step S222). In a case where the selected algorithm is not determined to be related to the seventh algorithm (tissue region Sf) (yes in step S222), the display control section 250 starts processing related to the selected algorithm. If the selected algorithm is any of the fourth algorithm ((MAX (ROI)), the fifth algorithm ((Ave (ROI)), and the sixth algorithm ((Mode (ROI)), the pixel value of the first image data is recalculated by the scaling factor sf associated with each basic region image included in the frame 302, and the image in the frame 302 (see FIG. 24) in which the dynamic range is adjusted is displayed on the display section 3 as the main observation image (step S224).

Subsequently, if the selected algorithm is the ninth algorithm (manual), the display control section 250 re-converts the pixel value of the first image data in each basic region image included in the frame 302 (see FIG. 24), which is the display image by using the value of the scaling factor MSf input via the display region 312 as expressed in the above-described Formula (4), and displays the obtained image on the display section 3 (step S226).

In contrast, in a case where the selected algorithm (see FIG. 24) is determined to be related to the seventh algorithm (tissue region Sf) (no in step S222), the display control section 250 adjusts the dynamic range of the main observation image on the basis of the statistic calculated in the image data in the tissue region in the image (step S228). Note that the image data to be displayed on the display section 3 may be displayed such that, for example, the luminance value of 0-655535, which is ushort16, is subjected to linear transformation, or subjected to nonlinear transformation such as logarithm transformation or biexponential transformation.

As described above, for example, luminance display can be quantitatively compared between images in units of the number of antibodies. Furthermore, the display dynamic range can be adjusted by a combination of the basic region images which each are smaller than a stitching image (WSI) even if there is a dye/region that is too dark to be visually recognized when the luminance of the stitching image (WSI) is adjusted. Therefore, it becomes possible to improve the visibility of the captured image. Furthermore, it is easy to compare the scaling factors Sf in the adjacent basic region images and to make the scaling factors Sf uniform. Therefore, the display dynamic ranges can be made uniform in a plurality of basic region images at a higher speed by performing rescaling on the basis of the single scaling factor Sf.

As described above, even if a region to be visually recognized is a dark dye/region, the dynamic range is more appropriately adjusted and the region can be visually recognized by allocating the image data to ushort16 (0-655535) by using the scaling factor Sf suitable for the dye/region. Furthermore, it is also possible to maintain the quantitativity by performing demodulation on the basis of the scaling factor Sf (=integrating the scaling factor with the image data ushort16).

As described above, according to the present embodiment, the first image data of the unit region image, a unit region being each region obtained by dividing the fluorescence image into a plurality of regions, is associated with the scaling factor Sf indicating the pixel value range for each piece of the first image data so as to be stored in the storage section 21 as a mipmap (MIPMAP). Therefore, on the basis of the representative value selected from the scaling factors Sf which are associated with respective unit region images of a combination of the unit region images in the selected region D, the pixel value of a combination image of the combination of the unit region images that have been selected can be converted. Therefore, the dynamic range of the selected unit region image is readjusted by using the scaling factor Sf, and all pieces the image data in the region D can be visually recognized in a predetermined dynamic range. As described, recalculation of the statistic calculation section 242 becomes unnecessary, and the dynamic range can be adjusted in a shorter time according to the position conversion of the observation region D. Furthermore, since the mipmap is stored in the storage section 21, one of the image levels L1 to Ln used for the main observation can be selected from the mipmap according to the selection level of the resolution, and the dynamic range of the main observation image can be adjusted and displayed on the display section 3 at a higher speed.

### Second Embodiment

An information processing device 2 according to a second embodiment is different from the information processing device 2 according to the first embodiment in that the information processing device 2 according to the second embodiment further includes a second analysis section that performs cell analysis such as cell count. Hereinafter, differences from the information processing device 2 according to the first embodiment will be described.

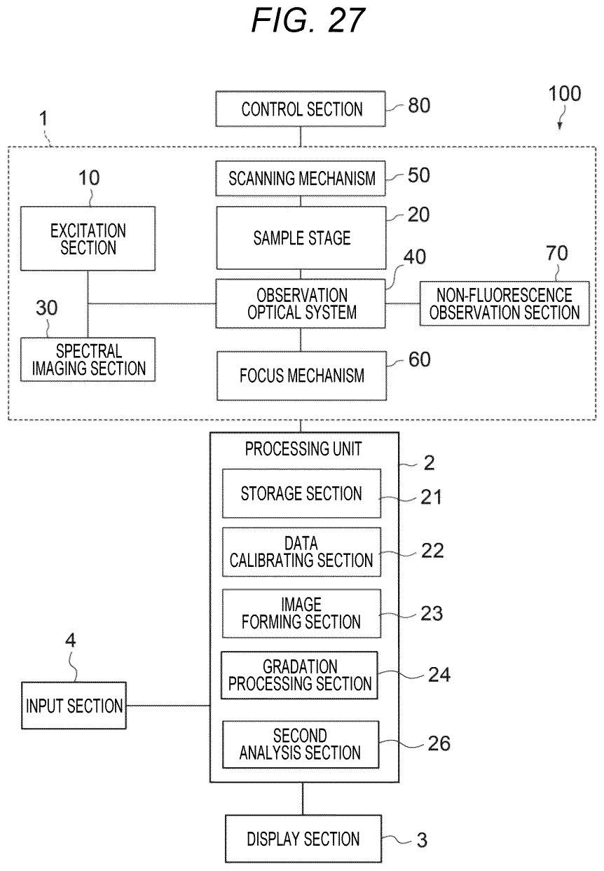

FIG. 27 is a schematic block diagram of a fluorescence observation device according to the second embodiment. As illustrated in FIG. 27, the information processing device 2 further includes a second analysis section 26.

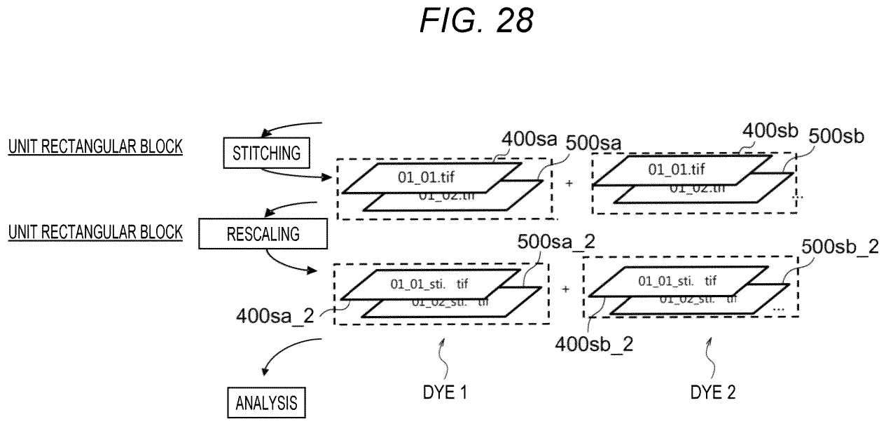

FIG. 28 is a diagram schematically illustrating a processing example of the second analysis section 26. As illustrated in FIG. 28, stitch processing for connecting images captured by an image forming section 23 to create one large stitch image (WSI) is performed, and an image group generation section 240 generates a mipmap (MIPmap). Note that, in FIG. 28, calculation is performed by setting minimum sections of the stitch-processed image as unit blocks (basic region images) 400sa, 400sb, 500sa, and 500sb.

A display control section 250 scales each basic region image in a visual field (display region D) selected by a horizontal operation region section 3060 and a vertical operation region section 3080 (see FIG. 24) with an associated sampling factor Sf, and stores the scaled basic region images in a storage section 21 as basic region images) 400sa_2, 400sb_2, 500sa_2, and 500sb_2.

In this manner, the second analysis section 26 determines the visual field to be analyzed after stitching, performs manual in-visual field rescaling and image output and then performs cell analysis such as cell count on each of multiple dye images. As described above, according to the present embodiment, analysis can be performed by using an image rescaled by an operator (user) in an arbitrary visual field. Therefore, it is possible to perform analysis in a region reflecting the intention of the operator.

### Modification 1 of Second Embodiment

An information processing device 2 according to Modification 1 of the second embodiment is different from the information processing device 2 according to the second embodiment in that a second analysis section 26 that performs cell analysis such as cell count performs automatic analysis processing. Hereinafter, differences from the information processing device 2 according to the second embodiment will be described.

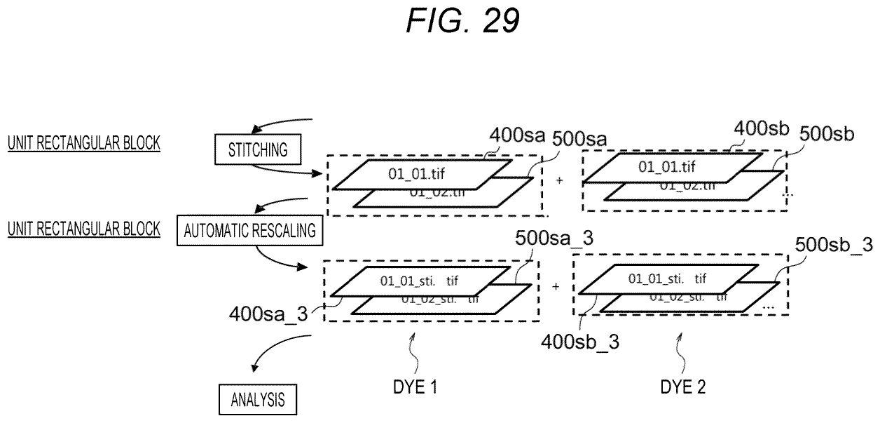

FIG. 29 is a diagram schematically illustrating a processing example of the second analysis section 26 according to Modification 1 of the second embodiment. As illustrated in FIG. 29, the second analysis section 26 according to Modification 1 of the second embodiment performs cell analysis such as cell count after automatic rescaling and image output by using a thumbnail result (small image having the highest existence probability of a tissue) and the like in the multiple dye images. As described above, according to the present embodiment, the second analysis section 26 can automatically detect a region where an observation target tissue exists and perform analysis by using the image automatically rescaled by using the scaling factor of the region.

### Modification 2 of Second Embodiment

A second analysis section 26 of an information processing device 2 according to Modification 2 of the second embodiment is different from the second analysis section 26 according to Modification 1 of the second embodiment in that the second analysis section 26 according to Modification 2 performs automatic analysis processing after performing automatic rescaling according to the eighth algorithm (auto). Hereinafter, differences from the information processing device 2 according to Modification 2 of the second embodiment will be described.

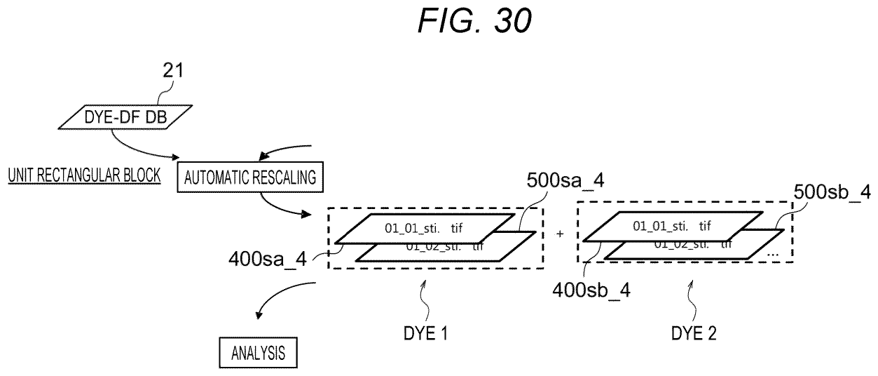

FIG. 30 is a diagram schematically illustrating a processing example of the second analysis section 26 according to Modification 2 of the second embodiment. As illustrated in FIG. 30, the second analysis section 26 according to Modification 2 of the second embodiment performs automatic rescaling by a function Sf (λ) (see Formula 11) of the representative value λ based on information stored in a storage section 31. That is, the function Sf (λ) as a rescaling factor is obtained by collecting data of the scaling factors Sf accumulated by the past imaging result and storing the data as scaling factors Sf for analyzing dyes and a cell in the storage section 31 as a database.

As described above, according to the present embodiment, past processing data is collected, the scaling factors Sf for analyzing dyes and a cell are accumulated as a database, and rescaled small images are stored as they are by using the scaling factors Sf of the database after stitching. Therefore, it is possible to omit a rescaling processing flow for analysis.

Note that the present technology can have the following configurations.
(1) An information processing method including:
   a storage step of storing first image data of a unit region image, a unit region being each region obtained by dividing a fluorescence image into a plurality of regions, and a first value indicating a predetermined pixel value range for each piece of the first image data in association with each other; and
   a conversion step of converting a pixel value of a combination image of a combination of the unit region images that have been selected on the basis of a representative value selected from among the first values associated with the unit region images of the combination of the unit region images that have been selected.
(2) The information processing method according to (1), in which the combination of the unit region images that have been selected corresponds to an observation range to be displayed on a display section, and a range of the combination of the unit region images is changed according to the observation range.
(3) The information processing method according to (2) further including a display control step of causing the display section to display a range corresponding to the observation range.
(4) The information processing method according to (2) or (3), in which the observation range corresponds to an observation range of a microscope, and the range of the combination of the unit region images is changed according to a magnification of the microscope.
(5) The information processing method according to (1), in which the first image data is image data in which a range of a dynamic range is adjusted on the basis of a pixel value range acquired in original image data of the first image data according to a predetermined rule.
(6) The information processing method according to (5), in which a pixel value of the original image data is obtained by multiplying the first image data with the representative value that is associated with the first image data.
(7) The information processing method according to (6), in which the storage step further stores second image data having a size different from a size of a region of the first image data, the second image data being obtained by subdividing the fluorescence image into a plurality of regions, and a first value indicating a pixel value range for each piece of the second image data in association with each other.
(8) The information processing method according to (7), in which a combination of pieces of the second image data corresponding to the observation range is selected in a case where a magnification of the microscope exceeds a predetermined value, and
   the conversion step converts a pixel value for the combination of the pieces of the second image data that has been selected on the basis of a representative value selected from the first values associated with the pieces of the second image data of the combination of the pieces of the second image data that has been selected.
(9) The information processing method according to (8), in which the pixel value range is a range based on a statistic in the original image data corresponding to the first image data.
(10) The information processing method according to (9), in which the statistic is any one of a maximum value, a mode, and a median.
(11) The information processing method according to (10), in which the pixel value range is a range between a minimum value in the original image data and the statistic.
(12) The information processing method according to (11), in which the first image data is data obtained by dividing a pixel value of the original image data corresponding to the unit region image by the first value, and
   the conversion step multiplies each piece of the first image data in the unit region images that have been selected by the corresponding first value and divides an obtained value by a maximum value of the first values associated with the combination of the unit region images that have been selected.
(13) The information processing method according to (12) further including:
   a first input step of inputting a method of calculating the statistic;
   an analysis step of calculating the statistic according to an input of the input section; and
   a data generation step of generating first image data obtained by dividing a fluorescence image into a plurality of regions and a first value indicating a pixel value range for each piece of the first image data on the basis of an analysis in the analysis step.
(14) The information processing method according to (13) further including a second input step of further inputting information regarding at least one of the display magnification or the observation range, and
   the conversion step selecting a combination of the first images according to an input of the second input step.
(15) The information processing method according to (14),
   in which the display control step causes the display section to display display modes related to the first input step and the second input step,
   the method further includes an operation step of giving an instruction on a position of any one of the display modes, and
   the first input step and the second input step input related information according to an instruction in the operation step.
(16) The information processing method according to (15), in which the fluorescence image is one of a plurality of fluorescence images generated by an imaging target for each of a plurality of fluorescence wavelengths, and
   the method further includes a data generation step of dividing each of the plurality of fluorescence images into image data and a coefficient that is the first value for the image data.
(17) The information processing method according to (16) further including an analysis step of performing cell analysis on the basis of a pixel value converted in the conversion step, and
   the analysis step of performing the cell analysis being performed on the basis of an image range of a range on which an instruction is given by an operator.
(18) An information processing device including:
   a storage section that stores first image data obtained by dividing a fluorescence image into a plurality of regions, and a first value indicating a predetermined pixel value range for each piece of the first image data in association with each other; and
   a conversion section that converts a pixel value of a combination image of a combination of the first images that have been selected on the basis of a representative value selected from among the first values associated with the first images of the combination of the first images that have been selected.
(19) A program causing an information processing device to execute:
   a storage step of storing first image data obtained by dividing a fluorescence image into a plurality of regions, and a first value indicating a predetermined pixel value range for each piece of the first image data in association with each other; and
   a conversion step of converting a pixel value of a combination image of a combination of the first images that have been selected on the basis of a representative value selected from among the first values associated with the first images of the combination of the first images that have been selected.

Aspects of the present disclosure are not limited to the above-described individual embodiments, but include various modifications that can be conceived by those skilled in the art, and the effects of the present disclosure are not limited to the above-described contents. That is, various additions, modifications, and partial deletions are possible without departing from the conceptual idea and spirit of the present disclosure derived from the matters defined in the claims and equivalents thereof.

### REFERENCE SIGNS LIST

2 Information device (Processing unit)
3 Display section
21 Storage section
248 Gradation conversion section
250 Display control section

1. An information processing method comprising:
a storage step of storing first image data of a unit region image, a unit region being each region obtained by dividing a fluorescence image into a plurality of regions, and a first value indicating a predetermined pixel value range for each piece of the first image data in association with each other; and
a conversion step of converting a pixel value of a combination image of a combination of the unit region images that have been selected on a basis of a representative value selected from among the first values associated with the unit region images of the combination of the unit region images that have been selected.

2. The information processing method according to claim 1, wherein the combination of the unit region images that have been selected corresponds to an observation range to be displayed on a display section, and a range of the combination of the unit region images is changed according to the observation range.

3. The information processing method according to claim 2 further comprising a display control step of causing the display section to display a range corresponding to the observation range.

4. The information processing method according to claim 2, wherein the observation range corresponds to an observation range of a microscope, and the range of the combination of the unit region images is changed according to a magnification of the microscope.

5. The information processing method according to claim 1, wherein the first image data is image data in which a range of a dynamic range is adjusted on a basis of a pixel value range acquired in original image data of the first image data according to a predetermined rule.

6. The information processing method according to claim 5, wherein a pixel value of the original image data is obtained by multiplying the first image data with the representative value that is associated with the first image data.

7. The information processing method according to claim 6, wherein the storage step further stores second image data having a size different from a size of a region of the first image data with respect to the fluorescence image, the second image data being obtained by subdividing the fluorescence image into a plurality of regions, and
a first value indicating a pixel value range for each piece of the second image data in association with each other.

8. The information processing method according to claim 7, wherein a combination of pieces of the second image data corresponding to the observation range is selected in a case where a magnification of the microscope exceeds a predetermined value, and
the conversion step converts a pixel value for the combination of the pieces of the second image data that has been selected on a basis of a representative value selected from the first values associated with the pieces of the second image data of the combination of the pieces of the second image data that has been selected.

9. The information processing method according to claim 8, wherein the pixel value range is a range based on a statistic in the original image data corresponding to the first image data.

10. The information processing method according to claim 9, wherein the statistic is any one of a maximum value, a mode, and a median.

11. The information processing method according to claim 10, wherein the pixel value range is a range between a minimum value in the original image data and the statistic.

12. The information processing method according to claim 11, wherein the first image data is data obtained by dividing a pixel value of the original image data corresponding to the unit region image by the first value, and
the conversion step multiplies each piece of the first image data in the unit region images that have been selected by the corresponding first value and divides an obtained value by a maximum value of the first values associated with the combination of the unit region images that have been selected.

13. The information processing method according to claim 12 further comprising:
a first input step of inputting a method of calculating the statistic;
an analysis step of calculating the statistic according to an input of the input section; and
a data generation step of generating first image data obtained by dividing a fluorescence image into a plurality of regions and a first value indicating a pixel value range for each piece of the first image data on a basis of an analysis in the analysis step.

14. The information processing method according to claim 13 further comprising a second input step of further inputting information regarding at least one of the display magnification or the observation range, and
the conversion step selecting a combination of the first images according to an input of the second input step.

15. The information processing method according to claim 14,
wherein the display control step causes the display section to display display modes related to the first input step and the second input step,
the method further comprises an operation step of giving an instruction on a position of any one of the display modes, and
the first input step and the second input step input related information according to an instruction in the operation step.

16. The information processing method according to claim 15,
wherein the fluorescence image is one of a plurality of fluorescence images generated by an imaging target for each of a plurality of fluorescence wavelengths, and
the method further comprises a data generation step of dividing each of the plurality of fluorescence images into image data and a coefficient that is the first value for the image data.

17. The information processing method according to claim 16 further comprising an analysis step of performing cell analysis on a basis of a pixel value converted in the conversion step, and
the analysis step of performing the cell analysis being performed on a basis of an image range of a range on which an instruction is given by an operator.

18. An information processing device comprising:
a storage section that stores first image data obtained by dividing a fluorescence image into a plurality of regions, and a first value indicating a predetermined pixel value range for each piece of the first image data in association with each other; and
a conversion section that converts a pixel value of a combination image of a combination of the first images that have been selected on a basis of a representative value selected from among the first values associated with the first images of the combination of the first images that have been selected.

19. A program causing an information processing device to execute:
a storage step of storing first image data obtained by dividing a fluorescence image into a plurality of regions, and a first value indicating a predetermined pixel value range for each piece of the first image data in association with each other; and
a conversion step of converting a pixel value of a combination image of a combination of the first images that have been selected on a basis of a representative value selected from among the first values associated with the first images of the combination of the first images that have been selected.
